(19) United States
(12) Patent Application Publication
(10) Pub. No.: US 2025/0035773 A1
(43) Pub. Date: Jan. 30, 2025

(54) METHODS AND SYSTEMS FOR FLYING SMALL OBJECT DETECTION USING RADAR

(71) Applicant: Matrixspace Corporation, Burlington, MA (US)

(72) Inventors: Dan William Nobbe, Crystal Lake, IL (US); Matthew T. Kling, Uxbridge, MA (US); Juan Heredia-Juesas, East Boston, MA (US); Sivagnanasundaram Ramanan, Boxborough, MA (US)

(21) Appl. No.: 18/783,846

(22) Filed: Jul. 25, 2024

Related U.S. Application Data
(60) Provisional application No. 63/528,745, filed on Jul. 25, 2023.

(51) Int. Cl. G01S 13/87; G01S 13/18; G01S 13/46

(52) U.S. Cl. CPC G01S 13/878; G01S 13/18; G01S 13/46; G01S 2013/468

(57) ABSTRACT

Systems and methods are provided for small object detection using radar. An example arrangement may include a plurality of radars, and at least one processing node that includes one or more processing circuits. The plurality of radars are physically separated. The plurality of radars is arranged such that coverage areas of the plurality of radars overlap, at least partially. The plurality of radars is configured to utilize differentiation techniques for differentiating each of the plurality of radars. The plurality of radars is configured to share detection related data obtained or generated by each of the plurality of radars based on detection of objects within the coverage areas. The one or more processing circuits are configured to process the shared detection related data and information relating to positions of the radars, to detect and/or track one or more objects.

### CLAIM OF PRIORITY

This patent application makes reference to, claims priority to, and claims benefit from U.S. Provisional Patent Application No. 63/528,745, filed on Jul. 25, 2023. The above identified application is incorporated herein by reference in its entirety.

### TECHNICAL FIELD

Aspects of the present disclosure relate to communication solutions. More specifically, various implementations of the present disclosure relate to methods and systems for detecting and accurately locating small moving objects using multiple radars.

### BACKGROUND

Operation of a radio frequency (RF) communication network in a dynamic, and sometimes hostile, RF environment poses many challenges, especially if the nodes in the network are highly mobile and the RF environment is rapidly changing. Each node is subject to interference, and the longer the distance to be covered, the more susceptible nodes are to interfering signals while power and antenna requirements increase.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for detecting and accurately locating small moving objects using multiple radars, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 shows an aerial drone that may be utilized in accordance with an example embodiment of the disclosure.

FIG. 2 shows a drone swarm that has formed a mesh network.

FIG. 3 shows an example artificial intelligence (AI) drone that may be utilized in accordance with an example embodiment of the disclosure.

FIG. 4A shows an example use of a radar for detection of small objects, such as golf balls.

FIG. 4B shows an example use of radar for detection ranging.

FIG. 5A illustrates example use of angle of arrival based detection.

FIG. 5B illustrates example use of monopulse detection.

FIG. 6 illustrates an arrangement with multiple radars for use in detecting and accurately locating and tracking small moving objects, in accordance with the present disclosure.

FIG. 7 shows an example use of multiple radars for detection of small objects with improved resolution.

FIG. 8A shows an example use of intersection of range resolution bands for detection of small objects.

FIG. 8B shows an example radar signature diagram illustrating angular variations in radar returns.

FIG. 9 shows example results from use of two radars in comparison to use of a single radar for detection of small objects, with respect to angular resolution in relation to distance from objects.

FIG. 10 shows an example use of multiple radars for detection of small objects with improved resolution, with the radars spaced separately in multiple directions.

FIG. 11 shows example results from use of two radars in comparison to use of a single radar for detection of small objects, with respect to angular resolution in relation to distance from objects, when the two radars are spaced separately in multiple directions.

FIG. 12 shows example effects of use of multiple radars with narrow beamwidth for detection of small objects, with multiple radars spaced at different positions in multiple directions relative to one another.

FIG. 13 shows different example placement arrangements when using multiple radars for detection of small objects.

FIGS. 14A-14F illustrate example use case demonstrating improved resolution of two-dimensional (2D) detecting and locating using multiple radars, in accordance with the present disclosure.

FIGS. 15A-15B illustrate example use case demonstrating improved resolution of three-dimensional (3D) detecting and locating using multiple radars, in accordance with the present disclosure.

FIG. 16 illustrates an example arrangement for back-calculate radar position determination, in accordance with the present disclosure.

FIG. 17 illustrates effects of small errors in time synchronization when using multiple radars in detecting and tracking non-stationary targets.

FIG. 18 illustrates effects of large errors in time synchronization when using multiple radars in detecting and tracking non-stationary targets.

FIG. 19 illustrates the configuration of different radars associated with FIGS. 17 and 18.

### DETAILED DESCRIPTION

Communications networks involve tradeoffs in range, bandwidth, power, and noise immunity. A mesh network is a form of network where the distance covered can be extended by hopping communications through intermediate nodes. Instead of hopping along a single path, a mesh topology allows a communication link to be set up on any of multiple paths through the mesh. A mesh routing protocol allows a link to be set up between any two nodes over any available path through the mesh. If a link is broken because of interference or loss of a node, the protocol establishes a new route through the mesh. Accordingly, a mesh network is resilient and self-healing.

Existing mesh network implementations use nodes that are largely static or operate with omnidirectional antennas, and operate at relatively lower frequencies. The present disclosure contemplates a mesh network of fixed or highly mobile nodes, with a preferred embodiment that operates as a swarm of aerial nodes, where the mesh may choose paths that reject interference based on directional properties of the node antennas and their transmission and reception. In addition, the network is implemented with millimeter (mm) wave radios. Millimeter wave is high frequency, high-bandwidth, and thus offers higher data rates, than Wi-Fi bands. The mm wave spectrum is also less crowded with competing applications, especially above the highest frequency cellular bands. Another advantage of mm wave is that antenna size decreases with increasing frequency, allowing for more sophisticated, higher gain antennas in smaller, lighter weight packages. Phased array antennas allow for increased gain, and in particular, by adjusting the phase and amplitude of each element in the array, the antenna gain can be adjusted and steered so that the antenna is highly directional and rapidly adjustable, an important feature for the highly dynamic nature of the disclosed mesh network.

In a mesh network of nodes with omnidirectional antennas, an interfering RF emitter will continue to interfere with nearby nodes no matter how the node is oriented relative to the interferer. Even if the node is mobile, changing the orientation of the node or minor adjustments in location are unlikely to alleviate the interference. However, by using a mesh network with directional antennas, such as phased array antennas, for example, nodes that are being interfered with may steer their antennas' beam patterns towards a node that is in a direction with less interference, use or select a different route through the mesh network that uses nodes whose antenna orientation is not aligned with the source of interference, and/or adjust the beam pattern so that a notch or null in the beam pattern is aimed at the interferer while only losing a slight amount of gain relative to peak gain. Nearby nodes that are within range of the interferer may also make these adjustments to their beam pattern as well. This may be done at high speed, with physically moving the node in space maintained as another option.

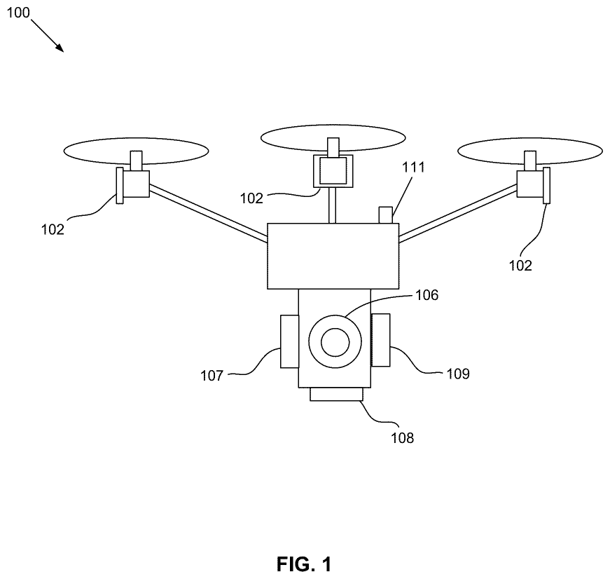

FIG. 1 shows an aerial drone that may be utilized in an accordance with an example embodiment of the disclosure. Shown in FIG. 1 is drone 100. The drone 100 is not crewed, and is preferably lightweight with a useful payload on the order of 10 pounds. The drone is equipped with directional, planar phased array antennas 102. While FIG. 1 only has three motor/blade mechanisms visible, there is a fourth directly behind the front one, although a higher number may be utilized, such as six, eight, or twelve for example. The arrays 102 can be mounted on any convenient surface on the drone to achieve the desired coverage based on the capability of the array, as further explained herein.

The drone is also equipped with sensors for collecting information. In the embodiment shown, the sensors include an optical imager 106, an infrared sensor 107, a LIDAR imager 108, an acoustic sensor 109, radar, and software-defined radio (SDR) for RF spectral sensing. The drone may comprise additional hardware for guidance, including a satellite position system antenna 111 and an inertial “dead reckoning” accelerometer and magnetic compass (not shown). The phased array antennas may be of any size, but are shown as 4×4 arrays in this embodiment, with an element size designed for the millimeter wave range, generally in the range of 10 to 200 GHZ. While any operating frequency could be chosen, the preferred embodiment operates at 24 GHz. In this mode of operation, line of sight communication of the radio links described herein is reasonable out to a single digit mile radius, with link distances typically under one mile.

Altitude is an important parameter for locating the drone in space, and essential for avoiding terrain. The drone preferably employs a combination of techniques for determining and maintaining altitude. Laser range finding, such as LIDAR, provides fast and accurate altitude information provided visibility is good. An on-board pressure altimeter provides a secondary reference, and the phased array antennas 102 may be used to provide ranging information to points on the ground using trigonometry if the ground surface is sufficiently reflective. Satellite provided Global Positioning System (GPS) or the like may also provide an estimate of altitude above the surface of the earth. Combining all these sources and comparing them to an on board reference map of the area of operation provides an accurate assessment of current altitude and contributes to a refined assessment of the drone's absolute position in space, further described below.

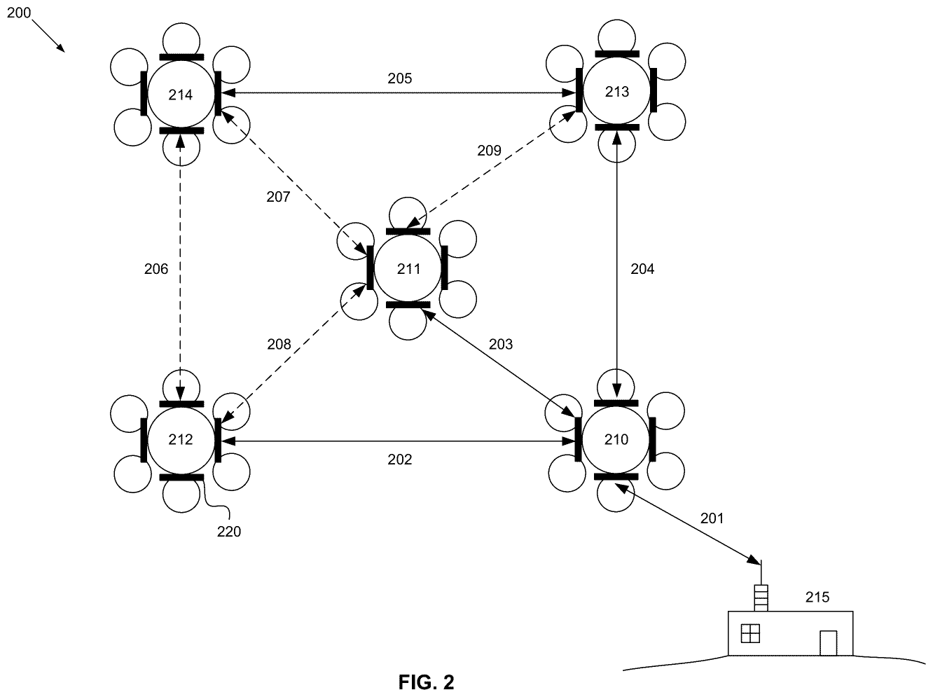

FIG. 2 shows a network 200 of aerial drones 210-214 forming a mesh network of links 201-209. Each of the drones 210-214 may comprise one or more phased array antennas 220, where the number of antenna arrays may ensure full 360° coverage. The network has a root at a ground or base station 215, which is shown as a static location but could also itself, be mobile. Dashed line links 206-209 represent alternate links between drones that are not active. Each drone acts as node in the network. It is not required that all nodes operate at the same frequency, and to avoid interference between nodes that are lined up such that a third further node is in the peak energy beam of a radio link between a first and second node, the network may employ several alternate neighboring frequencies.

Illustrated in FIG. 2 for illustrative purposes is a drone swarm of unmanned aerial vehicles or drones. Each drone in the swarm is also a communications node and is equipped with one or more phased array, electrically steerable antennas and a transceiver operating in the millimeter wave region. Each drone may also be equipped with one or more sensors, such as optical, LIDAR, thermal, or acoustic sensors. The drones carry an on-board processor and memory for controlling the drone's movements, operating the sensors, and managing the transceiver. The drones also carry antennas and a processor for determining position based on satellite data (e.g., Global Positioning System (GPS) or the like) and optionally an on-board inertial and magnetic (compass) sensor. The drones communicate with each other to form a mesh network of communication nodes with an RF link back to a root node, base station, or other target node in the network. The nodes respond to interference from jammers and obstacles by finding new paths through the mesh, steering the millimeter wave beam, re-positioning, or a combination of these techniques.

Path loss of a radio link increases proportional to the square of frequency. For example, going from 2.4 GHz which is roughly a common frequency for cell phones and 2.4 GHz Wi-Fi to 24 GHz would result in a path loss that is 100 times higher, or 20 dB. Going from 2.4 GHz to 80 GHz would have a 30 dB increase in path loss. In a free space propagation condition, the path loss increases by 20 dB for every decade of distance. Therefore, going from 2.4 GHz to 24 GHz would reduce the link distance by a factor of 10, and the link distance for an 80 GHz link would decrease by a factor of 33. However, high frequencies have the benefit of very wide bandwidths and thus faster data rates. Additionally, the size of the antenna decreases with frequency (wavelength), enabling the use of more complex, higher gain antennae to combat the increase in path loss. Higher gain results from focusing the energy, thereby resulting in highly directional antennas.

The phased array antenna consists of numerous antenna that have their amplitude and phase adjusted to steer the beam by adjusting summation and cancellation of signals from various directions. The focusing of the energy, often in both azimuth and elevation, creates a higher gain antenna. However, the very focused beam is preferably pointed in the right direction to facilitate communication. Additionally, the focusing of the beam means the transmission/reception in directions away from the main beam is attenuated, which may enable the avoidance of interference.

Furthermore, the phased antenna arrays may help with isolation of communication channels such as transmitting in one direction and receiving in another. Phased array antennae utilize software to control the gain/phase of each antenna element for steering of the beam, where the system is aware of which direction to steer the beam. The beams may be steered by knowledge of relative GPS locations or drone formation which may be known based on a flight plan or shared over a communications link. The beams may also be steered by scanning the beam and/or with closed-loop tracking. One typical implementation of a phased array antenna uses a planar array of patch antenna elements. This has the advantage of being flat and thus can fit well onto an aircraft without significant size and aerodynamic implications.

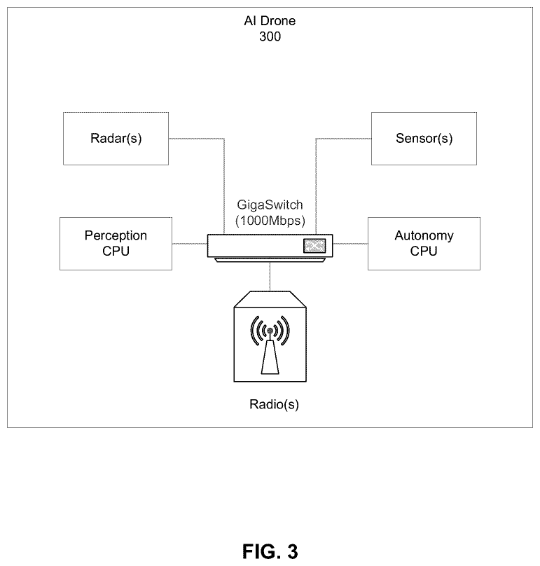

FIG. 3 shows an example drone that may be configured for improving radar angular resolution in accordance with an example embodiment of the disclosure. Shown in FIG. 3 is an aerial drone 300 (as described herein). The drone 300 may be manually operated or may operate autonomously (including, in some instances, being an AI drone).

The drone 300 may comprise suitable circuitry and other components (e.g., hardware or otherwise) to facilitate operation in accordance with the present disclosure. For example, the drone 300 may comprise radar(s), other sensor(s), communication module(s), and processors (e.g., central processing unit (CPU) processors, graphics processing unit (GPU) processors, etc.). In some instances, the drone 300 may be configured to facilitate or support use of advanced computing/processing based operations, such as artificial intelligence (AI) based operations. In this regard, circuitry and other components (e.g., hardware or otherwise) embedded in (or otherwise made available to) the drone 300 may be configured to support various advanced computing based tasks, such as real-time artificial intelligence (AI) computing/processing and data analytics, which may be used in conjunction with radar angular resolution related functions.

For example, as shown in FIG. 3, the drone 300 comprises a perception processor/circuit (or CPU), a autonomy processor/circuit (or CPU), radio(s), radar(s) and other sensor(s) for obtaining sensory related data, and a switch for facilitating interactions among the various elements of the drone 300. The perception processor/circuit (or CPU) and the autonomy processor/circuit may be configured to facilitate and support, inter alia, AI based sensing, data fusing, and data sharing functions, as described herein. The radio(s) may be configured for supporting communications by the drone 300, such as, e.g., with other AI drones and/or other network elements within a mesh network comprising the drone 300. The disclosure is not limited to particular type of radios, and various types may be used so long as suitable for operation in drone-based environment. In an example implementation, mesh based radios that may be optimized for supporting forming and operating mesh networks of drones are used. The radars may be configured to provide radar based detection, using known radar detection technique. The sensors may configured to obtain sensory data that may augment radar based data. The sensors may be configured to support, e.g., automatic dependent surveillance-broadcast (ADS-B) based sensory, camera feed, thermal imaging, etc. Radar may have strengths such as good range, good range and velocity resolution, fast scanning, and the ability to detect in poor visibility conditions (e.g., at night/fog/smoke). Cameras may have good angular resolution and may be better for object recognition. LIDAR may be good at mapping fine details, and so on. The techniques described in this application may be applied to a variety of sensors, not just radar. Furthermore, the concepts may also be extended to include combinations of sensors or fusion of the sensors to produce a more complete sensing solution.

In some instances, drones such as the drone 300 may be configured for improved data communications in drone based mesh networks. As noted the drone 300 may incorporate advanced radios such as the radar/communication module(s) 310, such as mesh based radios, which may support improved data communication. For example, the radar/communication module(s) 310 may support high-speed long-range data (e.g., >200 Mbps up to 1 km), may have large field of view (e.g., 120° in azimuth and elevation). The radar/communication module(s) 310 may support use of secure data link(s) (e.g., with AES-256 encryption).

In some instances, drones such as the drone 300 may be configured to provide and/or support use of local high bandwidth mesh to enable the drone to connect to other drones and/or network devices. Such local mesh may allow for connecting to drones, fixed sites (e.g., sensor(s) with radios), police cruiser, sensors, etc. For example, mesh connectivity may be provided using 24 GHz phased array, which may allow for communication at, for example, 400 Mbps at 600 m, 200 Mbps at 1 km, and/or 2 Mbps at 20 km. Local device connectivity may be provided using 802.11n dual band, which may allow up to 10 Wi-Fi users (e.g., at 433 Mbps), and/or via wired Ethernet for expanded users. Such mesh connectivity may be suitable for various use applications, such as distributed sensor networks, sensor fusion applications, etc.

In some instances, drones such as the drone 300 may be configured to form and/or operate within a sensor mesh. In such instances, some of the drones may comprise high performance embedded CPU and GPU processor(s) for use in data processing, particularly in conjunction with handling processing and fusing gather sensory data.

In some instances, drones such as the drone 300 may be configured to support various advanced computing based tasks, such as real-time artificial intelligence (AI) and data analytics, which may be used in conjunction with radar angular resolution related functions. In this regard, the drone 300 may be configured to provide software defined artificial intelligence (AI) sensing and autonomous responses. This may be particularly possible and/or optimized in conjunction with the radar angular resolution related functions. In this regard, such AI based solution may include and/or entails use of AI sensing, AI autonomy, and AI cloud services. With respect to AI sensing, data acquisition may be performed using advanced (e.g., mesh based) radars/radios. In this regard, formed RF meshes may enable new levels of data sharing for distributed sensing. Such radars may be optimized for drones or handheld devices. AI software may fuses optical and radar (data), such as using AI deep learning. The software may integrate data from 3rd party optical, LIDAR, thermal/IR and other sources as needed. Sensors may be handheld, ground based, and/or deployed on drones. The implementation of the disclosed software and/or sensing enables multiple object classification & tracking, even in foggy or smoky conditions.

Artificial intelligence (AI) Autonomy may be utilized when acting on acquired data. Sensors, people, vehicles and drones may coordinate data in real-time through RF mesh network. Autonomy software may be used to enable and ensure autonomous drone response and provide AI based assistance to operators. This may allow for multiple object classification and tracking, even in low visibility (e.g., foggy or smoky) conditions. Automated drones may extend sensing over distance and rapidly inspect areas of interest. This may allow for intelligent detect and avoid, or detect and track navigation. In some instances, sensor data may be rendered into detailed three-dimensional (3D) models (e.g., terrain, structures, areas of interest, etc.). The use of such service may also allow for detecting safety hazards (e.g., in structures, terrain, certain locations, etc.), and/or detecting safety/security issues. In some instances, open architecture may be used/supported to enable running or incorporate applications from different sources (e.g., combining provider's proprietary neural networks with user's and/or 3rd party's AI applications).

In some instances, drones such as the drone 300 may be configured for operation within network arrangements configured for other advanced and/or specialized services, such as, e.g., enabling enterprises-scale deployment of aerial vehicles, ground vehicles, fixed sensors, and more, interoperating with any existing networks using intelligent routing at the edge, and/or securing data from end-to-end using fully encrypted links (AES-256).

In accordance with the present disclosure, networks comprising drones such as the drone 300 may be configured for supporting improved radar angular resolution and overall target location ability. Overall target location ability may be improved by, e.g., fusing of radar based data with other sources (e.g., optical or the like). The improvement related measures or techniques may be implemented via a single platform or multiple platforms. In this regard, single platform based improvement may comprise one or more of: moving the platform for multiple observations, use of use of autonomous movement, use of advanced/optimized processing (e.g., artificial intelligence (AI) based processing), classifying objects (e.g., for optimized detection), sharing of information with other nodes (e.g., other drones, other nodes, ground stations, the cloud, etc.), sharing of information within a mesh (comprising plurality of similar platforms), and the like. When moving the platform for multiple observations, information such as location, heading, beam, etc. may be obtained and/or recorded for each observation point. In this regard, location and heading information may be obtained using suitable sensory techniques, such as global positioning (e.g., GPS), inertial measurement unit (IMU) based sensing, and the like.

Multiple platforms based improvement may be implemented via a plurality of platforms (e.g., combination of one or more of drones, non-drone mobile nodes, fixed nodes, etc.). In this regard, in some instances the single platform based improvement techniques as described herein may be applied at one or more of the multiple platforms utilized for multiple platforms based improvement. Further, multiple platforms based improvement may comprise one or more of: simultaneous or near simultaneous use of at least some of the multiple platforms, autonomous control of at least some of the multiple platforms, coordinated operation of other platforms, flying drones in formation, moving drones for improved location ability, use of passive detection, use of active and/or passive detection from drone to drone.

The simultaneous or near simultaneous use of platforms may comprise and/or entail coordinating (and thus sharing information relating to) such operation parameters as frequency, time, code, space related parameters, or combinations thereof. Passive detection may comprise (or entail) utilizing coded chirps, and entail selecting or setting such parameters as frequency and time related parameters. Coordinated operation of other platforms may comprise, for example, having one node alerting one or more other nodes to request observation and/or coordination of actions by the one or more other nodes. This may comprise or entail sharing or coordinating such information as location(s), target, beam steering, etc. Implementations incorporating use of the improved radar angular resolution and overall target location ability as described herein may have various practical applications—e.g., in drone navigation/detection, in security solutions, in ground based perimeter, in ground vehicle based solutions, in aviation based solutions, in marine based solutions, in golfing and other sports, in local air traffic solutions. These techniques may also be applied to any sport where the radars may be used to track objects such as baseballs, softballs, soccer balls, hockey pucks, as well as players. The use of these techniques may result in improved track accuracy. These concepts may be applied to areas where multiple radars are placed with overlapping coverage areas to produce improved detection and tracking accuracy for targets such as drones and airplanes. Furthermore, these concepts may be applied in settings requiring perimeter security, such as prisons, boarders, bases, and cities, where multiple radars are deployed along a perimeter or throughout an area to provide coverage. Radars with overlapping coverage regions may use these techniques to produce improved angle accuracy and other benefits. Use of such measures or techniques in improving radar angular resolution, and example use cases based thereon, are described in more detail below.

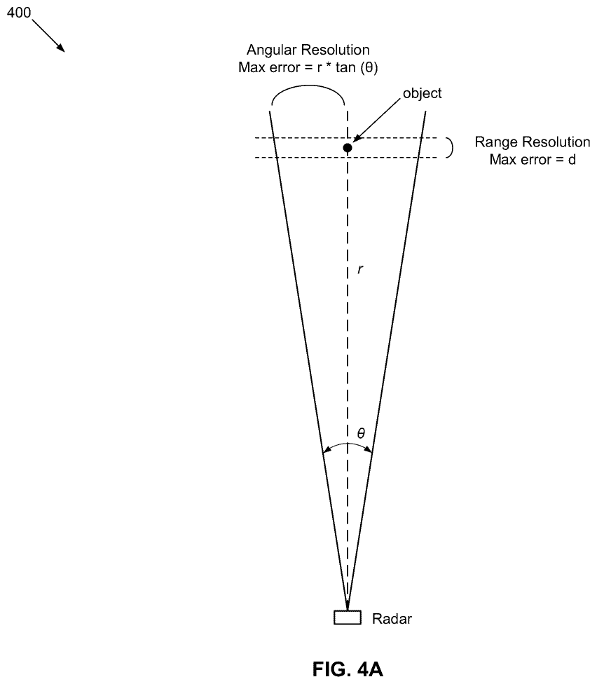

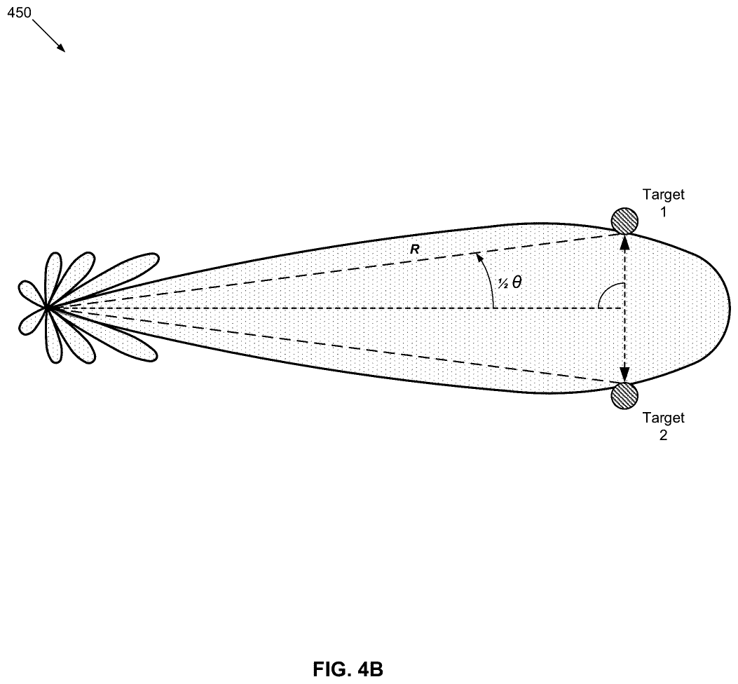

FIG. 4A shows an example use of a radar for detection of small objects, such as golf balls. Shown in FIG. 4A is diagram 400 illustrating use of a single radar in detection of small objects, such as golf balls, as well as demonstrating limitations and issues that may arise from such use.

As illustrated in FIG. 4A, radars may be used in detection of objects within their transmission ranges. In this regard, such radars may be deployed adaptively—e.g., on mobile platforms, on fixed platforms, at ground level, elevated, etc. Various performance parameters and attributes may typically be associated with use of radars, including, e.g., range and range resolution, radar angular resolution, the ability to resolve targets, particularly under certain conditions (e.g., at night, in fog and bad weather, etc.), the ability to provide additional information about detected objects such as velocity, and the like. Performance parameters and attributes typically relate to antenna size, radio power and performance, bandwidth, waveform processing, and similar physics-based tradeoffs. In this regard, different performance parameters and attributes may require different (and at times contradictory) operational or physical requirements.

For example, range resolution and angular resolution may be particularly relevant to detection of objects, especially small objects, such as golf balls. In this regard, radar angular resolution quantifies the limits in radar's ability to distinguish objects in terms of angle between direct beams or lines to different locations at the same range (distance) from the radar. In other words, radar angular resolution may represent the smallest angle between two positions at the same range from the radar where the radar may still be capable of distinguishing between with respect to the presence of the object therein. Radar range resolution quantifies the limits in radar's ability to distinguish objects in terms of range (distance) between different locations at the same line from the radar. In other words, range angular resolution may represent the smallest distance between two positions on particular beam or line from the radar that the radar may still be capable of distinguishing between with respect to the presence of the object therein. Angular resolution is typically inversely proportional to antenna size, and signal processing techniques may be used to improve resolution. Range resolution is typically a property of the radar design, and specifically the bandwidth. The radar angular resolution and radar range resolution may be characterized or expressed in terms of maximum errors corresponding to each of these parameters.

In the example use case illustrated in FIG. 4A, a small object (e.g., golf ball) is detected using radar beam(s), with the detection being characterized in terms of range r and beamwidth angle θ. The beamwidth angle may be determined based on the structure and/or configuration of the radar. For example, in many existing solutions, the beamwidth angle θ may be 30°. Nonetheless, reducing the beamwidth angle θ may desirable, as it may result in enhanced resolution, and as such smaller beamwidth angles (e.g., down to) 2° may be utilized if available. The range resolution maximum error may be d, which is as noted may be limited by the design of the antenna. The smaller the range resolution maximum error d is the more accurate the detection would be. The angular resolution maximum error is a function of the resolution angle θ and range r, specifically in accordance with the formula: r*tan (θ). As such, the smaller the resolution angle θ, the smaller the angular resolution maximum error is at a given range, and the more accurate the detection would be.

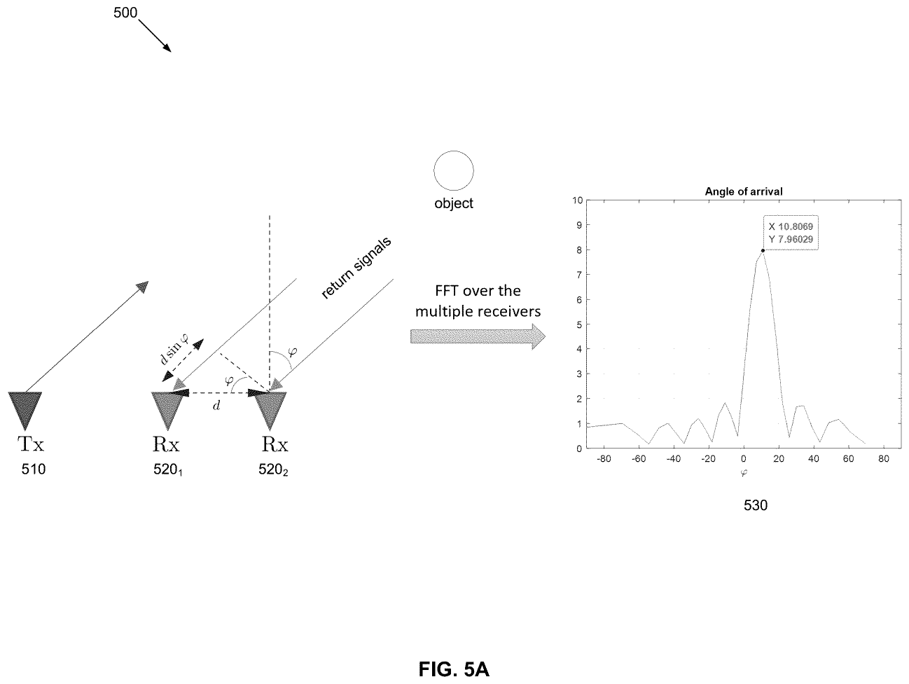

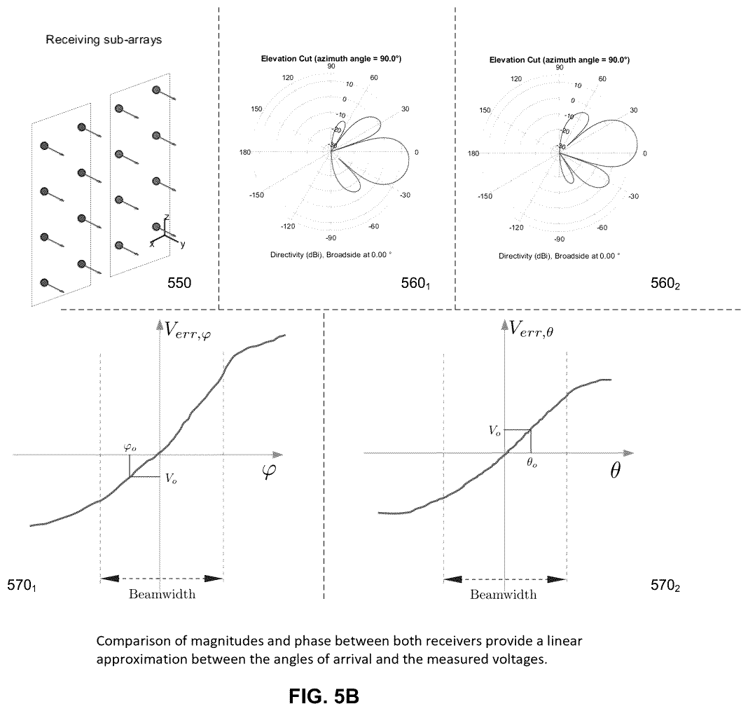

These performance parameters may be particularly pertinent for detection of small objects, especially when moving (e.g., golf balls in flight). This may be especially the case when using radars that may be mounted on drones. In this regard, limited angular resolution of small form factor radar may result in undesired resolution for such use scenarios—e.g., golf driving range or golf course based applications. For example, with angular resolution of 2°, the ball position resolution may significant be 7 yards at a distance of 200 yards. This may be addressed by, e.g., use of multiple radars that operate in coordinated manner, particularly to enhance range resolution and/or angular resolution. Such solutions may be particularly useful in applications based on or entailing detection of small objects, such as for improving resolution of golf ball position detection. Use of multiple radars and example implementation based thereon are described in more detail below with respect to FIGS. 5-11.

FIG. 4B shows an example use of radar for detection ranging. In this regard, radar provides numerous benefits including good range and range resolution, radar angular resolution, the ability to resolve targets at night, in fog and bad weather, and the ability to provide additional information such as velocity.

Performance attributes typically relate to antenna size, radio power and performance, bandwidth, waveform processing, and similar physics-based tradeoffs. Radar angular resolution is another performance parameter that is pertinent to overall performance of radars. In this regard, radar angular resolution quantifies the limits in radar's ability to distinguish between different objects based on the angle between direct beams or lines to these objects from the radar. In other words, radar angular resolution may represent the smallest angle between two objects at particular range from the radar where the radar may still be capable of identifying these objects as separate objects. In the example use case illustrated in FIG. 4B, two objects (also referred to herein as targets) are detected using radar beam(s), with information relating to the detection including range (R) to each target, and angle (θ) between the two direct lines from the radar to the targets. In this regard, as used herein targets may be of different size—e.g., ranging from small objects (e.g., flying golf balls) to substantially large objects (e.g., planes). Radar angular resolution is typically dependent on beamwidth of antenna—e.g., typically relates to the −3 dB beamwidth of the antenna. In this regard, radar angular resolution relates to the beamwidth of the antenna. Additional processing such as monopulse processing can be used to further improve the angular accuracy. Monopulse techniques use multiple antennas such as portions of a phased array antenna and compare the amplitude, phase, or both amplitude and phase of the multiple received signals to improve the target location accuracy.

In some instances, when trying to locate an object in space using a radar, range resolution may be better than the spatial resolution provided by the angular resolution at that range. This may be particularly the case at longer ranges and/or wider beamwidth radars. In this regard, with reference to the use case scenario illustrated in FIG. 4B, range resolution may correspond to the length of the line between the two objects (e.g., planes) in FIG. 4B. That line is equal to 2R*sin (θ/2). Angular resolution may not only be set based on the beamwidth, but may also be based on a variety of other techniques such as monopulse as well. In this regard, other techniques may be used to improve the resolution. In the example use case shown in FIG. 4B, the two targets are each at the −3 dB points on the beam and thus not resolved—that is, there may not be sufficient radar angular resolution to distinguish between the two targets. Therefore, improving radar angular resolution is desirable.

Beamwidth relates to the size of the antenna (e.g., a parabolic antenna in the example use case illustrated in FIG. 4B), with beamwidth being determined using the formula: beamwidth=70*λ/D, where D is the diameter of the antenna and λ is the transmitted wavelength. The beamwidth of the antenna also relates to the gain or more appropriately the directivity of the antenna, where gain increases as the antenna size increases. Thus, a radar system may realize improved range and radar angular resolution with a larger antenna. However, there are many cases where the size of the antenna is limited, such as based on size of the intended host platform as would be the case with aerial drones.

Accordingly, in various example implementations, measures may be used to improve the angular resolution of radars, such as radars used in aerial drones. Example measures may include fusing radar data with other data (e.g., optical data), moving the radar platform, using multiple radar systems for triangulation, using multiple drones flown in formation, creating features or distortions of the antenna beam, etc. In some example implementations, one or more of such measures may be used to improve radar angular resolution. While in various example implementations described herein the host platform is described as being a drone, the disclosure is not so limited, and as such other types of host platforms may be used, such as a ground vehicle, ground installation, etc. In this regard, examples of the ground installation would be a deployable or fixed mount sensor on a golf course or other athletic event, for example. Also, in some example implementations a set of ground nodes are used to observe a certain region such as a local air traffic monitor or perimeter security system. Nonetheless, a host platform needs to be mobile in the case that a single radar platform is being moved to improve the location accuracy. In some instances, a combination of platforms may be used—e.g., one or more drones operating in combination with one or more ground stations.

In example implementations where radar data are fused with other data, such as optical data, a radar system may be able to indicate an object at a distance in a certain area (within the beamwidth) well before an optical system may locate a target. The target may show up as a single pixel or small number of pixels that are difficult to distinguish in an optical image. However, if the system is configured to determine that there is an object in a certain region, the image processing may be optimized to locate the target.

In some instances, the radar system may be configured to identify a sub-image described or bounded by the radar beamwidth for further image processing. Such improvement may be especially useful on a platform such as drone, particularly for such functions as sensing and avoidance. Nonetheless, the utility of such improvement is not limited to drones and drone based example implementations, and may also be useful in other types of example implementations, such as in automotive based example implementations. In this regard, the automotive environment may be a high clutter environment and typically short range radar are used, and as such improving radar angular resolution would result in improved overall performance.

In some instances, an alternative approach may be used, with radar data being used for range with optics being used for location. In this regard, optical pixel may adequately determine location, but it may be hard to determine range with an optical image. Thus, optical detection may be used to filter radar data—e.g., remove false alarms in radar data. In other words, a process based on such approach includes detecting with optical image first, then using radar data for ranging. It is also possible to use radar data first to detect an object, then use the optical image to determine location. These approaches “fuse” data from radar systems and optical systems to enhance detection capabilities of the system.

In some instances, laser imaging, detection, and ranging (LIDAR) are used to provide additional data for use in combination with radar data. In this regard, LIDAR may provide a dense point cloud where radar (using angle of arrival) only gives target information (angle and distance) for targets above a certain threshold.

In accordance with the present disclosure, solutions are provided for detecting and accurately locating and tracking non-stationary (moving) objects, particularly small moving objects. In particular, such solutions may address challenges and limitations associated with detecting, locating, and/or tracking such objects, such as by incorporating various measures for improving range resolution and angular resolution of sensors (e.g., radars) used in the detecting, locating, and/or tracking of the objects. In this regard, range resolution and angular resolution (or errors associated therewith) may adversely affect the detection, location, and tracking of certain objects, particularly small objects and/or non-stationary (moving) objects.

For example, it may be typically difficult to accurately locate an object in three-dimensional (3D) space when using a radar. This is especially true for small objects with small radar cross-sectional areas (e.g., golf balls or the like). As explained above, it may be hard to resolve angle to target with broad antenna beamwidth. In this regard, wide angular range of targets may be possible with the same range. While a radar may have good range resolution it may still have challenges with angular resolution. As described above with respect to FIG. 4A, radar's range resolution maximum error (or simply range resolution), d, may be much smaller than the angular resolution (r*tan (θ)) at far distances. In this regard, range resolution, d, is known for the radar example implementation, as it is based on the bandwidth (BW) of the radar signal, and is determined using the formula d=c/(2*BW), where c is the signal speed, which for radar is the speed of light. Even with techniques such as monopulse, it is difficult to achieve angular resolution below a few degrees. When projected out to far distances, this translates to a large window of possible locations. The point at which the range resolution equals the angular resolution is r=d/(tan (θ)). Conventional solutions do not sufficiently address the challenges associated with detecting, locating, and/or tracking objects, particularly small moving objects. FIGS. 5A-5B illustrated examples of such conventional solutions.

FIG. 5A illustrates example use of angle of arrival based detection. Shown in FIG. 5A (not drawn to scale) is a radar arrangement 500 that allows for angle of arrival based detection. In particular, the radar arrangement 500 comprises a transmitter 510 and a pair of receivers 5201 and 5202. Arrangements similar to the radar arrangement 500 typically may be used in automotive radars.

The radar arrangement 500 is configured to use angle of arrival based detection. In this regard, the radar arrangement 500 may perform Fast Fourier transform (FFT) to the signal collected at each of the receivers 5201 and 5202, to compare the phase differences. Diagram 530 illustrates the collected FFT points. The peak the FFT points to the angle of the target with respect to the radar.

Use of angle of arrival based detection, as illustrated with respect to the radar arrangement 500, may have some limitations, however. In this regard, angle of arrival based detection usually suffers from a small angular resolution since angular resolution typically improves with the number of receivers (increase thereof), and small factor radars (e.g., phases array radars) typically incorporate a small number (few) receivers. Further, in order to compute both azimuth and elevation angles, 2 FFTs would be required, and the receivers should be arranged in a 2D plane, increasing the hardware and software complexity. In addition, angle of arrival based detection works best at close distances, and may not be as reliable at long distances.

FIG. 5B illustrates example use of monopulse detection. Shown in FIG. 5B is a radar arrangement 550 that allows for monopulse detection. In particular, the radar arrangement 550 comprises a plurality of receivers (or receiving sub-arrays). For example, as shown in FIG. 5B, the radar arrangement 550 comprises 2 receiving sub-arrays. Arrangements similar to the radar arrangement 550 typically may be used in military monopulse radars.

The monopulse detection technique takes advantage of utilizing receivers with different squint angles. In this regard, in monopulse detection additional encoding of the radio signal may be used to provide more accurate directional information, which allows the system to, e.g., extract range and direction from a single signal pulse. The monopulse detection may be implemented by phase detection on one axis and amplitude detection on the second axis. Amplitude detection may be enabled by beam squinting. For example, the receive array may be split into two portions. In some cases this may be an even split of the array. The two portions of the array each have a dedicated receiver path that allows for unique signal processing. One can compare the phase difference between the two portions to determine the angle of arrival of the reflected signal (from the target). This satisfies determination of the angle orthogonal to the direction of the split between the array portions. For example, this may produce the azimuth angle or one axis. To achieve angle of arrival resolution in the direction orthogonal the first determined angle (e.g., in elevation), one may use amplitude squinting to create an imbalance in the amplitude response of the two portions along the second (elevation) angle or second axis. For example, one portion may be intentionally steered 10 degrees above the nominal antenna direction and the second portion may be steered 10 degrees below the nominal antenna direction. If for example the reflected signal from the target arrived at an angle 10 degrees above the nominal antenna direction, a comparison of the two amplitudes would show that the portion of the antenna steered 10 degrees above the nominal antenna direction would have a higher signal output. This amplitude comparison is done using the same two receiver paths. This hybrid approach of using phase and amplitude techniques allows for a minimal number of receive paths while still producing the bi-directional angle resolution that is desired. The radar already produces a good representation of range, so that combining range, azimuth, and elevation angles would let the radar locate an object in three dimensional space).

For example, in the radar arrangement 550, the two receivers have different squint angles, as illustrated in antenna patterns shown in the polar-coordinate radiation plots 5601 and 5602. The squinting is done in elevation to enable amplitude monopulse detection of elevation angles. The phase between the two receivers is used to detect azimuth angles. These two receivers are used in receiving signals, and corresponding phase and magnitude (as illustrated in phase-magnitude plots 5701 and 5702) are generated based on the signals received by the two receivers. Then, both phase and magnitude differences are compared. In this regard, the combination of these two values is related to the azimuth and elevation angles of the signal with respect to the radar.

Use of monopulse detection, as illustrated with respect to the radar arrangement 550, may have some limitations, however. For example, the relationship (phase and magnitude differences) is unambiguous within the beamwidth of the main beam, meaning that it only works within the beamwidth of the phased array. However, by applying beam steering the range of detecting angles could be highly increased. The estimated angles may take any value within the beamwidth limits, meaning that it is not dependent on the discretization grid that is required when performing an FFT. However, monopulse detection is affected by noise, being degraded when the signal values are close to the noise floor level. In this sense, the ability to resolve two targets in the angular domain depends on the characterization of the noise of the received signals.

Another technique that may be used in some conventional solutions is narrow radar antenna beamwidth, which is used in certain Federal Aviation Administration (FAA) radars. A narrow beamwidth requires a larger antenna. Larger antennas are not viable for many applications, especially when cost, power, and/or portability are important.

Solutions based on the present disclosure may address challenges of detecting, locating, and/or tracking such objects, and particularly overcoming the limitations associated with conventional solutions, such as by incorporating various measures for improving range resolution and angular resolution. In particular, in example implementations based on the present disclosure multiple radars are used, being arranged and/or configured to operate in collaborative manner when detecting, locating, and tracking objects. For example, multiple radars (2 or more) may be used to detect objects, and triangulate position of each detected objects. In this regard, locations of the radars and relative ranges from the radars to the objects may be used. As such, there may be a need to share data from the multiple radars, to facilitating post-processing of the data (including, e.g., combining of the results), to facilitating the detecting, locating, and tracking of objects. Shared data may comprise, for example, locations of radars, range related data (measured range to object, range resolution, and angular resolution), timestamps or other timing related information (indicating, e.g., when detection and/or range measurements are made), etc. The processing of the shared data may be performed in a central manner—e.g., via one or more of the radars, via local network node, in the cloud, or any combination thereof. Such use of multiple radars working collaboratively may improve the probability of detection and reduces the probability of false tracks. Nonetheless, the present disclosure may not be limited to use of radars, and as such in some implementations, other types of sensors may be used in lieu of radars, if suitable for implementing the various features and functions attributed to the radars as described in the present disclosure. Further, in some implementations, the multiple radars may incorporate additional sensory resources for use in conjunction with radar related resources and functions, to facilitating the detecting, locating, and tracking functions as described herein.

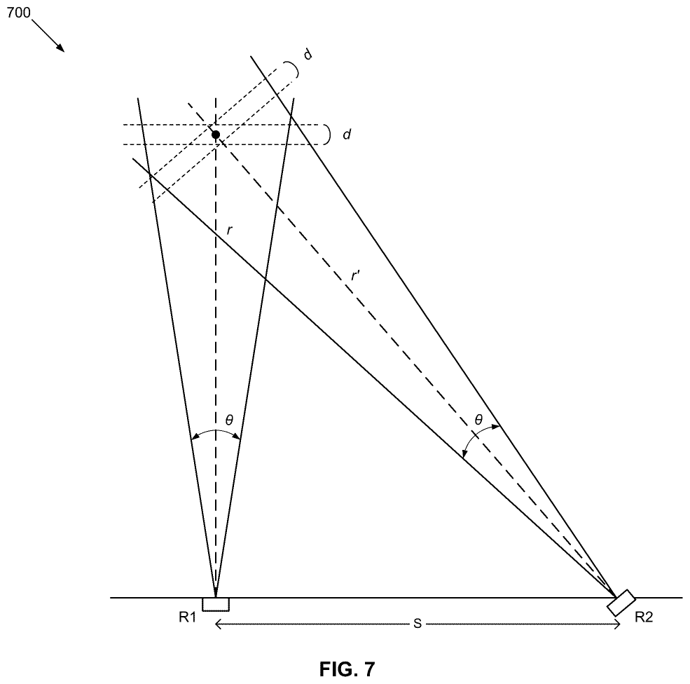

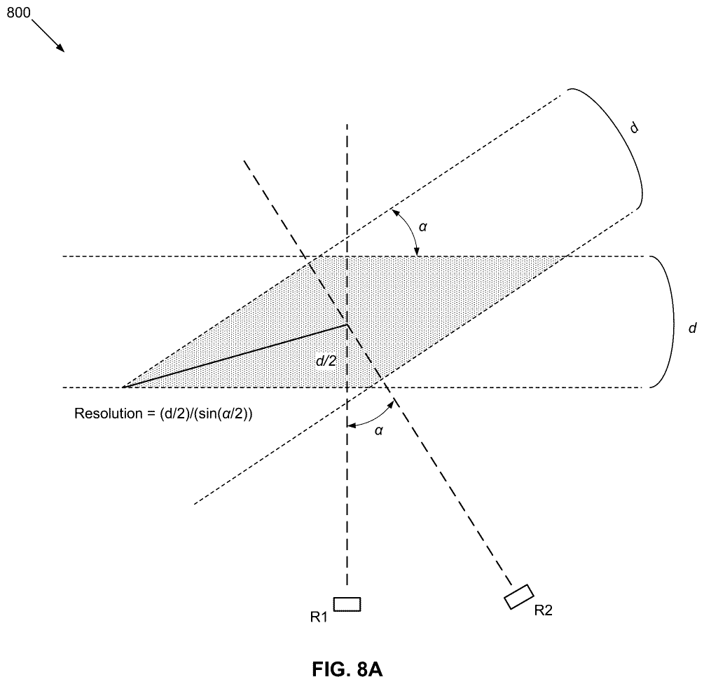

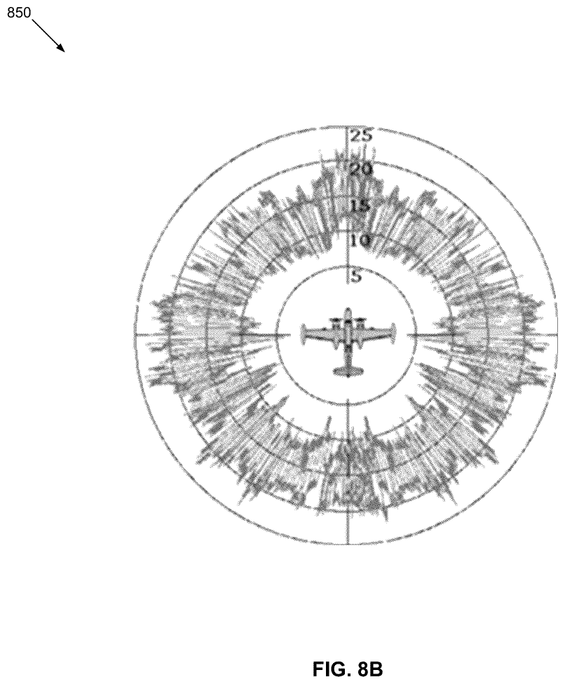

In various implementations, measures and techniques may be used to further improve the detection, locating, and tracking of objects when using multiple radars. For example, at longer distances, uncertainty in an object's lateral position may increase increases—e.g., as explained with respect to FIG. 4A, since the slice/region of uncertainty corresponding to the possible positions would be wider the farther the object is from the radar. In particular, especially where radars are spaced and positioned in optimal manner, the two slices/regions of uncertainty corresponding to each of the two radars may intersects, yielding a smaller area of uncertainty (corresponding to the intersection of the two regions), which may be much smaller than the r*tan (θ) region (of each radar) described above. The use of multiple radars may minimize such uncertainty. This is illustrated and described in more detail with respect to FIGS. 7-8.

In some instances, the spacing, configuration, etc. of the radars allow for minimizing the uncertainties in the radar detection (e.g., due to range resolution and angular resolution). For example, spacing between the multiple radars is important. This may comprise both distances between and relative positions of the radars. In this regard, increased spacing between the radars may help reduce errors (e.g., position estimation errors). However, increased spacing may also result in reduced overlapping coverage, which is needed. Thus, it is important to weigh the different effects when spacing the radars.

Use of shared information (e.g., when processing such data for purposes of detecting, locating, and tracking objects) may require additional information and/or additional actions. For example, processing shared information may require location of each of the multiple radars to be known, and the relative ranges. Processing shared information may also require time synchronization between the radars. In this regard, time synchronization may be needed to enable determining reliably, and to account for when the radar measurements were made, and to time-align the measurements, particularly for a moving object.

In some instances, various configuration measures may be used to eliminate or minimize interference between the radars. For example, the multiple radars may be configured to utilize suitable multiplexing techniques (e.g., Time Division Multiple Access (TDMA), Frequency Division Multiple Access (FDMA), Code Division Multiple Access (CDMA), etc.) and modulation in general including chirp structure scanning patterns, polarization techniques, etc., and/or various combinations thereof, to ensure that transmissions by the multiple radars are sufficiently separated so that they do not interfere with each other. Chirp structure may include up chirps, down chirps, and/or non-linear chirp waveforms.

In some instances, multistatic based implementations may be used. In this regard, in such multistatic implementation, some of the multiple radars may not transmit but would receive and then use the received signals in combination with location of transmitting radar(s) to make the relative range measurement to particular objects.

In some instances, radar(s) with scanning capability may be used, as such capability may help to offset some of the challenges relating to the spacing of the radars.

In some instances, radar bias may be determined and corrected, to further enhance the detection, locating, and tracking of objects when using multiple radars. For example, in some implementations, back-calculate radar position techniques may be used to estimate Bias in radar Positions, and to determine and make corrections based thereon.

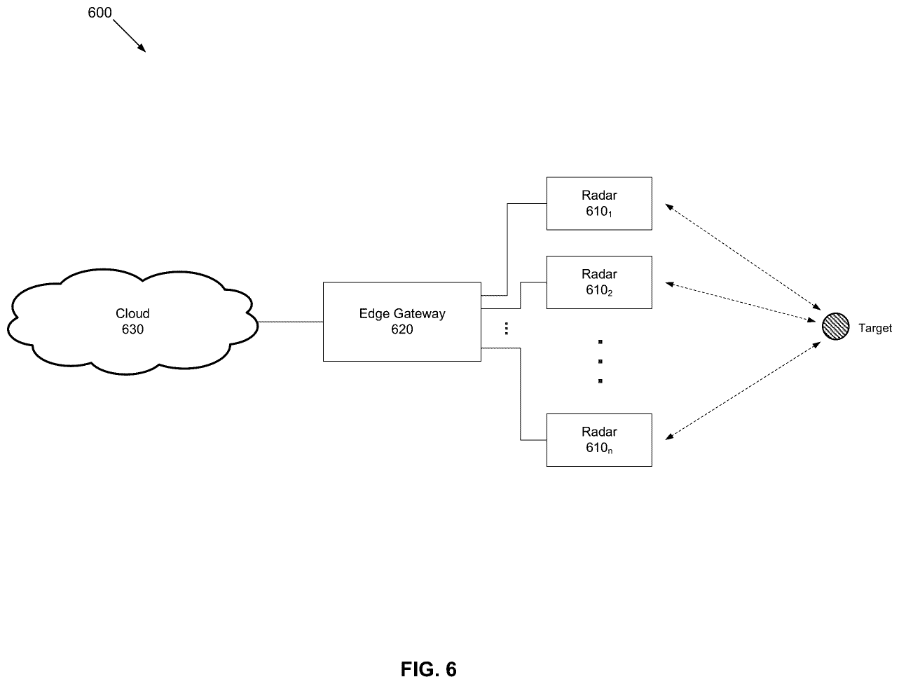

These various aspects and features, and additional ones are described in more detail below with respect to FIGS. 6-18.

FIG. 6 illustrates an arrangement with multiple radars for use in detecting and accurately locating and tracking small moving objects, in accordance with the present disclosure. Shown in FIG. 6 is arrangement 600 that is configured for supporting detecting and accurately locating and tracking small moving objects. As illustrated, the arrangement 600 comprises a plurality of radars 610ₗ-610ₙ, an edge gateway 620, and cloud (network) 630.

Each of the plurality of radars 610ₗ-610ₙ, may comprise suitable circuitry and other resources (e.g., antennas, power resources, etc.) for providing radar based detection. Nonetheless, in some implementations, other types of sensors may be used in lieu of radars, if suitable for implementing the various features and functions attributed to the radars as described in the present disclosure. Further, in some implementations, the multiple radars may incorporate additional sensory resources for use in conjunction with radar related resources and functions, to facilitating the detecting, locating, and tracking functions as described herein.

The edge gateway 620 may comprise suitable circuitry and other resources (e.g., communication resources, sensory resources, etc.) for providing network edge extension related services and functions. This may comprise extending network edge(s) beyond reach of coverage areas of current 4G/LTE, 5G, etc. In this regard, extending the network edge may comprise, e.g., providing high bandwidth and low latency mesh connectivity with cloud backhaul, enabling point-of-operations real-time data communication (including, e.g. video streaming) to/from local nodes without having to go through the cloud, streaming to cloud for near real-time data services, data storage, and offline analysis, and/or performing advanced edge computing (e.g., for real-time artificial intelligence (AI) and data analytics).

Edge gateways, such as the edge gateway 620, may be used provide local coverage to network nodes (including, e.g., drone(s)), as well as local users (e.g., via hotspot), and cloud access (e.g., to enable remote access). The edge gateway 620 may be configured to enable establishing and servicing local mesh network, for providing local connectivity among local network nodes, including moving nodes (e.g., drones), fixed sites (e.g., fixed sensor(s), fixed radars, etc.), etc. As noted, extending network edge(s) may include and/or require cloud access. In this regard, cloud access may be done in secure manner, such as through virtual private network (VPN), which is typically unavailable in existing solutions—that is, existing drones and feeds provided thereby may not include or entail use of VPN. Within the arrangement 600, the edge gateway 620 may be used to facilitate connectivity among the plurality of radars 610ₗ-610ₙ, and between the cloud 630 and the plurality of radars 610ₗ-610ₙ, and for providing central processing, such as with respect to information obtained using the plurality of radars 610ₗ-610n.

The cloud (network) 630 may comprise suitable circuitry and other resources for providing cloud based networking and computing functions and/or services. In this regard, the cloud 630 may comprise, e.g., one or more servers (and other systems) for providing cloud based data storage, data processing, data access, etc., in a distributed manner.

In operation, the plurality of radars 610ₗ-610n may be configured to provide, collaboratively, unified tracking or target representation. In this regard, the plurality of radars 610ₗ-610ₙ may be used to monitor common coverage area, and to detect, locate and track objects that may present within that area. The objects (also referred to as ‘targets’) may comprise small objects, which may also be non-stationary. The detecting, locating and tracking may be improved by use of multiple detection measurements, by multiple radars. In this regard, angular resolution and/or range resolution may be improved when using such multiple detection measurement compared to the angular resolution and/or range resolution associated with detection measurements of individual radars. This is described in more detail below.

In some instances, the multiple detection measurements may be used for the tracking of movement of the target and/or for determining trajectory of the target. In this regard, the multiple detection measurements may be used, when processed collectively, in extrapolating movement of the target forward and backward, which may be used in tracking of movement and/or trajectory of the target. This may allow for locating origin of target and trajectory of its movement (e.g., where the golf ball was hit, and also its landing point, which may be hard to detect when on the ground).

In some instances, the processing of multiple detection measurements may be done in one or more network nodes, and may be done in real-time. For example, the processing of multiple detection measurements, and computations based thereon (e.g., to determine movement or trajectory of the target) may be done in the edge gateway 620, and in real-time. In this regard, as noted, the edge gateway 620 may have processing resources required for performing the necessary central processing. As such, the edge gateway 620 may be configured for receiving and processing (including combining) data from multiple devices, including the plurality of radars 610ₗ-610ₙ, or other types of sensors.

In some instances, the edge gateway 620 may be omitted, and one (or more) of the plurality of radars 610ₗ-610n may be configured to handle the processing (including combining) of data from the plurality of plurality of radars 610ₗ-610n.

In some instances, the function of the edge gateway could reside in one of the radar modules, assuming the radar module can handle the computations required.

In some instances, at least portion of the multiple detection measurements (and the information obtained based thereon) may be shared into the cloud 630 (e.g., for further processing, display, etc.).

In some instances, the plurality of radars 610ₗ-610n may be configured to generate and associated with detection measurements obtained thereby timing related information, such as time stamps. In this regard, use of time stamps may allow for determining location at particular time even when the processing (e.g., combining) is done later in time.

In instances where there may be multiple targets, the plurality of radars 610ₗ-610n will need to coordinate to identify target(s) of interest, and share information relating only to the target(s) of interest. Where multiple target(s) of interest are being tracked, the shared information will be specifically identified (as to which target of interest the information pertains). The differentiating among the target(s) of interest may be done by the device handling the processing and combining of shared information—that is, the edge gateway 620.

FIG. 7 shows an example use of multiple radars for detection of small objects with improved resolution. Shown in FIG. 7 is diagram 700 illustrating use of two radars for detection of small objects, such as golf balls.

In this regard, as noted above performance parameters such as angular resolution and range resolution may be particularly pertinent for detection of small objects, especially when such small objects are moving (e.g., golf balls in flight). Using multiple radars, particularly when such radars are placed at different angles, may result in improved performance, particularly with respect to angular resolution and range resolution, even without any modifications to the individual radars or operation thereof. In this regard, to enhance detection of small objects, processing of multiple radars, placed at different angles, may be fused such that the range resolution, and improvement thereof, may allow for improving angular resolution.

For example, as illustrated in FIG. 7, two radars (R1 and R2) may be used, placed apart such as along a lateral direction (x-direction in diagram 700) relative to the object being detected, being spaced from one another by particular distance S. In this regard, in golf related applications, the x-direction may represent or correspond to a straight line at the back of (or across from and opposite to) the tee off area in golf driving range or golf course, with the radars being placed along that line. The two radars may be similar structurally and functionally, and thus may have the same beamwidth angle θ. The ranges (distances) from the two radars, R1 and R2, to the object may be, respectively, r and r′. While the angular resolution and the range resolution, and maximum errors therein, for the two radars may be the same, the use of the two radars will still result in improved resolution, due to overlap in coverage areas of the multiple radars. This is illustrated in and explained in more detail with respect to FIG. 8A.

FIG. 8A shows an example use of intersection of range resolution bands for detection of small objects. Shown in FIG. 8A is diagram 800, illustrating expanded view of the overlap area between the beams of two radar when used in detection of objects. In this regard, the diagram 800 may correspond to the overlap area between beams of radars R1 and R2 of FIG. 7.

As illustrated in FIG. 8A, the shaded trapezoid area may results from intersection of the areas corresponding to the two range resolution bands of the two radars. Areas such as the shaded trapezoid area are referred to herein as “region of confidence” or “range resolution intersection.” This intersection, and the corresponding overlap area, may result in improved resolution. In this regard, the intersection-based resolution may be determined based on the formula:

$$Resolution = ( d / 2 ) / ( sin ( α / 2 ) )$$

where d is the range resolution maximum error, and α is the angle between the beams of the two radars.

As such, resolution improves as the angle α increases. Thus, increasing the spacing between the two radars should result in improved resolution as the angle α would increase. However, the limit case is a 90° angle, where the trapezoid area becomes a square with sides equal to the range resolution in x and y dimensions. An example radar signature illustrating variations in radar returns based on angle is shown and described with respect to FIG. 8B.

In example implementations, range resolution related techniques may be used to further enhance detecting, locating, and/or tracking of objects using multiple radars. For example, range resolution related techniques may be used. In this regard, as noted range resolution for a radar is a function of the bandwidth of the radar. The range resolution is independent of range. Excellent range resolution is possible with wide bandwidth radars. For example, a radar with 200 MHz of bandwidth has a range resolution, r, of 0.75 m, as determined using the formula of r=c/(2*BW). Such range resolution is true for a target that is 100 m away and also for a target that is 5 km away. Angular resolution and accuracy are more challenging for a radar. Nonetheless, any suitable techniques for improving angular resolution may be used. The positional accuracy that is realized is a function of the target's range. The farther the target, the wider the dispersion of possible locations for a given angular resolution. The angular and range resolution considerations are illustrated in and described above with respect to FIG. 4A.

In some instances, the range resolution of multiple (2 or more) radars may be leveraged at different locations to improve the overall resolution, as illustrated in FIGS. 7-8. The limit case is when two radars are placed at 90 degree angles, in which case the resolution is completely set by the range resolution. In this regard, the arrangement illustrated in these figures is 2-dimensional (2D) based arrangement, and as such, only two radars may be used. For similar is 3-dimensional (3D) based improvement, 3 or more radars may be needed, with the locations of these radars spaced in 3D space (x, y, z based space).

FIG. 8B shows an example radar signature diagram illustrating angular variations in radar returns. Shown in FIG. 8B is diagram 850 illustrating example radar signature for an object (e.g., airplane). In particular, the diagram 850 illustrates the radar signature of the objects from different angles. The radar signature comprises radar returns from the object from different angles (relative to the object). In this regard, the radar return from an object varies as the angle to the object is varied, such as when the object is moving. From the image in FIG. 8B, it may be seen that the peaks are around 24 dB square meter (dBsm), and the minimums are lower than 5 dBsm. This relates to the size of the object, the wavelength of the radar signal, the material of the object, and the feature complexity of an object. Radars that view the same object from different vantage points will have different responses, and while one radar may see a very small return, the other radar may see a large return. This relationship may change over time. Having the ability to combine these returns or detections from individual radars will result in an increased number of detections.

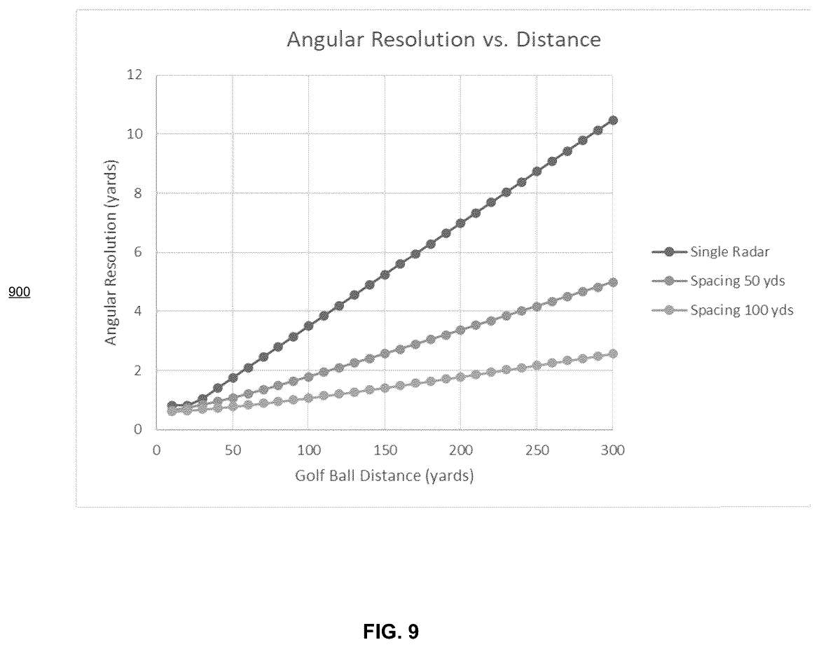

FIG. 9 shows example results from use of two radars in comparison to use of a single radar for detection of small objects, with respect to angular resolution in relation to distance from objects. Shown in FIG. 9 is graph 900, which is a standard x-y graph.

In this regard, the x-axis in graph 900 is distance to the golf ball (in yards) whereas the y-axis is angular resolution (expressed in yards for the given distance to the target). As shown in FIG. 9, graph 900 illustrates performance results in terms of angular resolution, as a function of range (distance to the object), when using a single radar compared to use of two radar, and additionally for two different use scenarios associated with the use of the two radars: 1) with the two radars spaced 50 yards in the same lateral direction (x-direction in diagram 700) relative to the object, and 2) with the two radars spaced 100 yards in the same lateral direction relative to the object. As illustrated in graph 900, use of multiple radars and increasing spacing of the radars results in improved resolution.

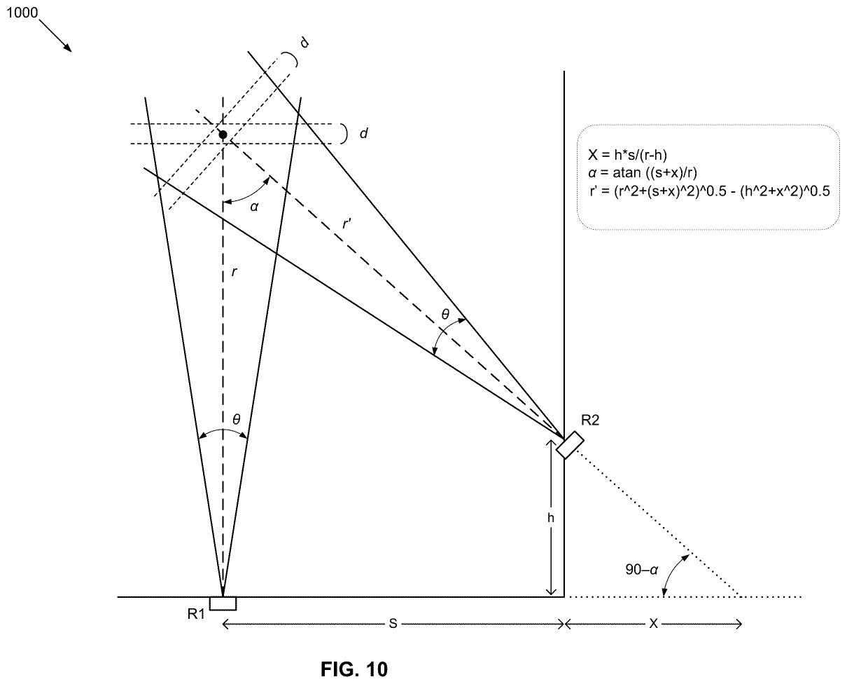

FIG. 10 shows an example use of multiple radars for detection of small objects with improved resolution, with the radars spaced separately in multiple directions. Shown in FIG. 10 is diagram 1000 illustrating the use of two radars for detection of small objects, such as golf balls.

In this regard, as noted above use of multiple radars may result in improved performance, particularly with respect to angular resolution and range resolution, in conjunction with applications based on or entailing detection of small objects, particularly when such small objects are moving (e.g., golf balls in flight), even without any modifications to the individual radars or operation thereof. In this regard, in the example implementations described with respect to FIGS. 5-7, the radars are only spaced apart in a single direction-namely, in the lateral direction relative to the object (x-direction in diagram 1000). However, in some instances, one or more of the radars may also be moved in another direction-namely, in the depth direction relative to the object (y-direction in diagram 1000).

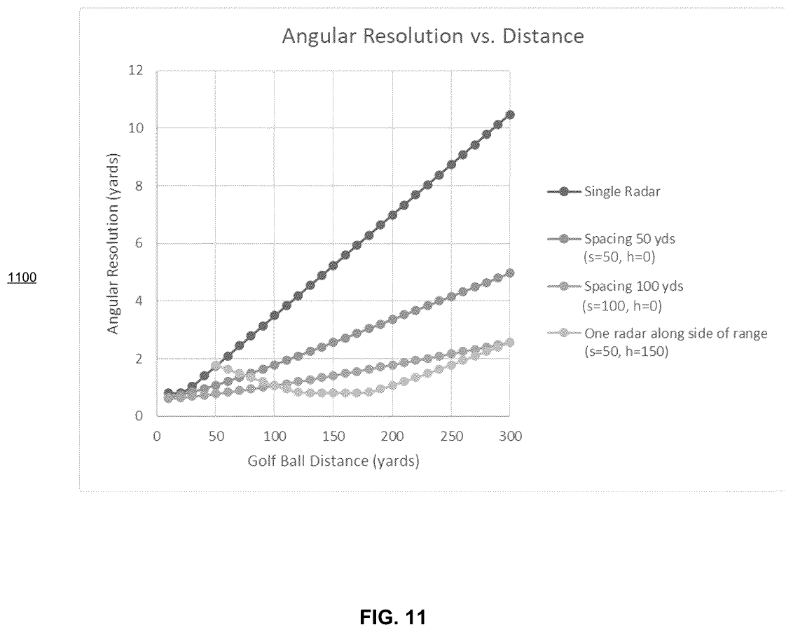

For example, as illustrated in FIG. 10, two radars (R1 and R2) may be used, placed at a distance S such as along the lateral direction relative to the object being detected (x-direction in diagram 1000). The two radars may be similar structurally and functionally, and thus may have the same beamwidth angle θ. However, the two radars (R1 and R2) may additionally be placed apart along the depth direction relative to the object (y-direction in diagram 1000). As shown in FIG. 10, radar R2 may be placed at distance h from the lateral line on which radar R1 is placed. The ranges (distances) from the two radars, R1 and R2, to the object may be, respectively, r and r′. While the angular resolution and the range resolution, and maximum errors therein, for the two radars may be the same, the use of the two radars will still result in improved resolution, due to overlap in coverage areas of the multiple radars, and may further be improved by placing one of the radars (radar R2) at different depth. This is illustrated in and explained in more detail with respect to FIG. 11. The placement of the radars may be determined using the formulas:

$$X = h * S / ( r - h ) .$$

$$α = atan ( ( S + X ) / r ) .$$

$$r ’ = ( r \hat{} 2 + ( S + X ) \hat{} 2 ) \hat{} 0.5 - ( h \hat{} 2 + X \hat{} 2 ) \hat{} 0.5 .$$

FIG. 11 shows example results from use of two radars in comparison to use of a single radar for detection of small objects, with respect to angular resolution in relation to distance from objects, when the two radars are spaced separately in multiple directions. Shown in FIG. 11 is graph 1100, which is a standard x-y graph.

In this regard, the x-axis in graph 1100 is distance to the golf ball (in yard) whereas the y-axis is angular resolution (in yard). As shown in FIG. 11, graph 1100 illustrates performance results in terms of angular resolution, as a function of range (distance to the object), when using a single radar compared to use of two radar, and additionally for three different use scenarios associated with the use of the two radars: 1) with the two radars spaced 50 yards in the lateral direction relative to the object (different points along x-direction in diagram 800), 2) with the two radars spaced 100 yards in the lateral direction, and 3) with the two radars spaced 50 yards in the lateral direction and additionally spaced 150 yards in depth direction relative to the object (different points along y-direction in diagram 1000).

As shown in graph 1100, use of multiple radars, increasing spacing of the radars in the lateral direction results in improved resolution, and additionally placing the radars at different depths—that is, at different points along the depth direction-relative to the object in conjunction with the spacing the radars in the lateral direction yields further improvements with respect to angular resolution, at least within particular distance range (e.g., 100 to 300 yards).

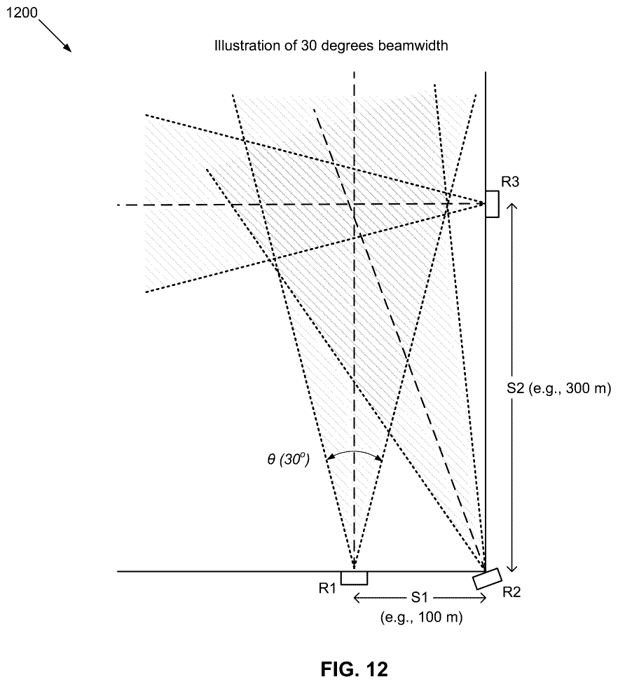

FIG. 12 shows example effects of use of multiple radars with narrow beamwidth for detection of small objects, with multiple radars spaced at different positions in multiple directions relative to one another. Shown in FIG. 12 is diagram 1200 illustrating use of three radars for detection of small objects, such as golf balls.

In this regard, as noted above use of multiple radars may result in improved performance, particularly with respect to angular resolution and range resolution, in conjunction with applications based on or entailing detection of small objects, particularly when such small objects are moving (e.g., golf balls in flight), even without any modifications to the individual radars or operation thereof. In this regard, in the example implementations described with respect to FIGS. 5-9, only two radars were used, being spaced apart in one or two directions. However, in some instances, more than two radars may be used.

For example, as illustrated in FIG. 12, three radars (R1, R2, and R3) may be used, with the 3 radars arranged such that two of them (R1 and R2) placed apart along the lateral direction relative to the object being detected (x-direction in diagram 800) by distance S1, with the third radar (R3) being spaced from one of the other two (e.g., from radar R2) along the depth direction relative to the object (y-direction in diagram 800) by distance S2. In this regard, the spacing distances may be different. For example, as shown in diagram 1200, S1 may be 100 m whereas S2 may be 300 m. The three radars may be similar structurally and functionally, and thus may have the same beamwidth angle θ. For example, as shown in diagram 1200, each of the 3 radars may have beamwidth angle θ of 30°.

The use of the three radars may further improve resolution during detection operations. In this regard, the combination of two radars spaced in the lateral direction (R1 and R2) produces a large area of overlap and improved resolution. Adding the third radar (R3), especially with the side placement (spaced in the depth direction by S2), may further improve performance, yielding the best resolution in the area of overlap between all three beams. However, one limitation with such arrangement is that the area of overlap (and thus best performance) may be very small. In some implementations, phased array antenna may be utilized as steering capability of phased array antenna may allow for increasing resolution improvement overlap region by sweeping the radar. Accordingly, use of multiple (more than 2) radars may yield fewer data points, but may result in even more improved resolution.

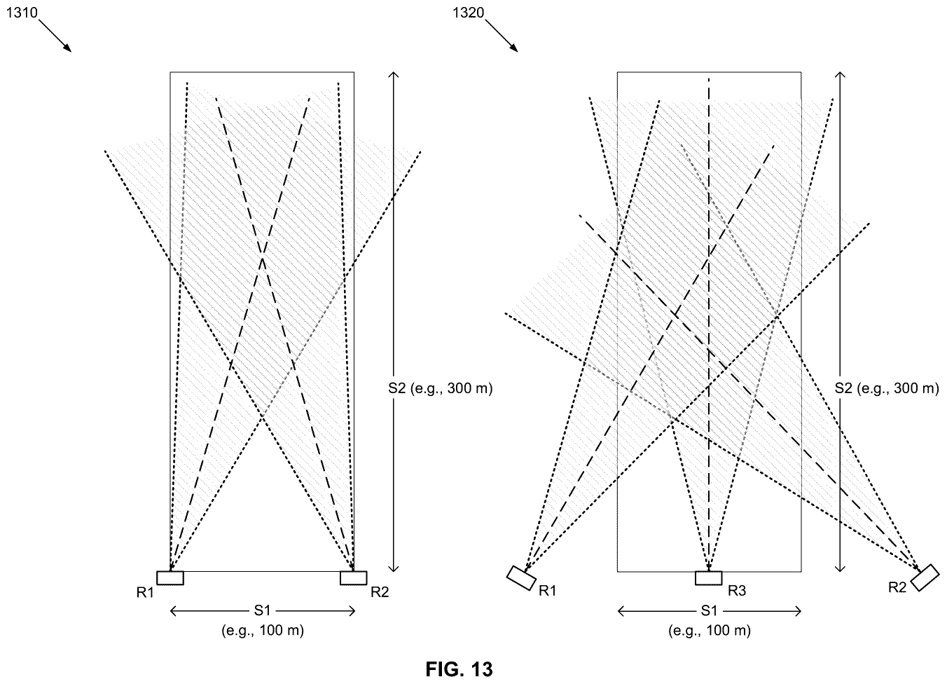

FIG. 13 shows different example placement arrangements when using multiple radars for detection of small objects. Shown in FIG. 13 are diagrams 1310 and 1320 illustrating two different radar arrangements that may be used for detection of small objects, such as golf balls.

In this regard, in the radar arrangement represented in diagram 1310 two radars (R1 and R2) are used, spaced from one another along the lateral direction (x-direction in diagram 1310), whereas in the radar arrangement represented in diagram 1320 three radars (R1, R2, and R3) are used, also spaced from one another along the lateral direction (x-direction in diagram 1320). The two arrangements illustrate how important the initial launch data is and possibility of using one radar focused toward an area of interest (e.g., tee off area in driving range or golf course). In this regard, such initial data may be used to seed the trajectory model used in detecting and track the objects (golf balls). For example, as illustrated in diagrams 1310 and 1320, one or two radars (R3 in diagram 1320, R1/R2 in diagram 1310) may be placed down the range and pointed towards the tee off area. Different considerations may also be pertinent in selecting and configuring the radar arrangement. For example, maximizing separation in the x-direction may provide largest overlap region and high angle. On the other hand, use of more radars (e.g., 3 radars) with larger offsets and different orientations may create large overlap region with increased angles.

In example implementations, spacing related techniques may be used to further enhance detecting, locating, and/or tracking of objects using multiple radars. In this regard, use of the multiple radars in detecting, locating, and/or tracking of objects requires the radars to have overlapping coverage regions. Ensuring and optimizing such overlapping may be challenging, however. The position resolution may be improved with offset radar locations, but the overlapping coverage regions may be degraded with large positional offsets. For example, in the radar arrangement 1000 illustrated in FIG. 10, the radars are placed at a large relative angle, which results in overlapping beams covering a small area (the small trapezoid area around the target).

In other words, increased spacing—that is, distance and/or angle between the radars—may help reduce the position estimation error, but may result in reduced overlapping coverage (which is needed). Use of more radars (3 or more radars) may allow for improving coverage regions even more, as illustrated in FIGS. 12-13, and/or for extending this concept to 3-dimensions.

In some instances, other techniques may be used in conjunction with (or in lieu of) spacing, in controlling overlapping coverage regions. For example, in some implementations, antenna steering can help address the overlapping coverage regions. Scanning the antenna across multiple beam locations greatly improves the coverage area. The illustrations show a single beam location for each radar, but the radars may be capable of scanning angles such as 100 degrees in azimuth and 70 or even 100 degrees in elevation. Assuming a single radar is placed behind a golfer, and assuming an antenna beamwidth of 28 degrees, scanning 1 beam location in azimuth and 2 in elevation will cover the shot dispersion of pro golfers. Increasing the scanning pattern to 3 azimuth beams and 2 elevation beams will cover a wide range of golfers. For example, if the beam is stepped from center beam locations of −18 degrees, 0 degrees, and +18 degrees, it would cover an azimuth range of 18*2+28=64 degrees.

In example implementations, location and/or time synchronization related techniques may be used to further enhance detecting, locating, and/or tracking of objects using multiple radars. In this regard, location synchronization may be required because combining shared detections and triangulating position of objects properly may only be done when the locations of the radars are known. Location synchronization may require that the locations of the multiple radars be known, and various techniques may be used to do that. For example, x, y, z based location of each radar may be obtained (or shared—e.g., with device or node providing central processing), and the location data may be fused together.

One example technique for determining the locations of the radar is the use of GPS or similar geolocation capabilities—e.g., incorporating into or combining them with the radar. Use of such technique may be feasible easier if the radars are in a fixed location, where precision GPS tools may be used and the locations recorded. In some instances, calibration steps may be used if the location is fixed (e.g., place target at a few fixed locations and check the relative distance measurements of the radars). If the locations are fixed, physical measurements may be made.

In instances where the radars are deployed on moving platforms (e.g., drones), and particularly where the radars are actually moving during detection operations, location related resources may be required. For example, GPS-like resources (e.g., GPS receivers) may be incorporated into the platforms. Such GPS receivers may have certain measure of uncertainty (e.g., about 2 m of uncertainty). As such, in some instances, additional measures may be used to improve the GPS measurement, such as Real-time kinematic positioning (RTK), differential, or averaging over time.

Another technique for calibrating that may be used is comparing reported locations of the radars, such as to determine which radars may not be reliable. For example, if one of the radars is consistently inconsistent compared to the remaining ones—e.g., 3 of 4 radars ‘agree’ on location of a target while the 4th radar provides different location—that radar may be ignored.

In some instances, location synchronization may be performed using the relative locations of the radars—that is, x, y, z location of each radar relative to one or more other radars as basis when triangulating.

In addition to location, orientation of the radars may also be needed. However, orientation(s) of the radars may not be needed if using range information only—that is, when the range resolution intersection is identified. Nonetheless, orientation may help, such as when used with range and angle, in locating, selecting, and/or qualifying the target. For example, when utilizing monopulse for angle resolution improvement, the location accuracy of the cone and thus its ability to locate a target may be pertinent, especially when multiple targets are in view, and as such range resolution overlap may be used to improve the accuracy, and orientation of radars may help ensure that.

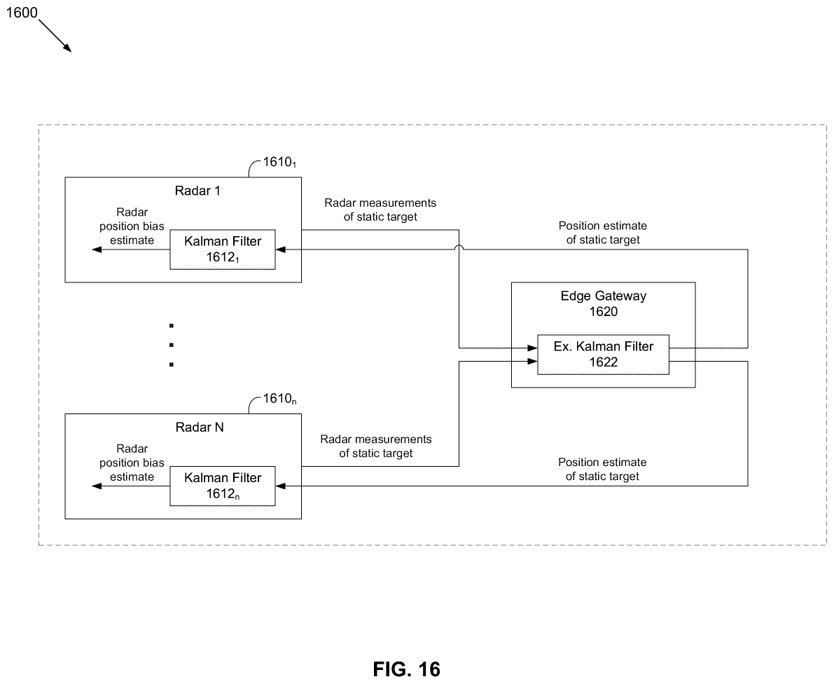

In some instances, back-calculated radar locations may be used, since with the use of multiple radars to calculate locations of targets, it is necessary to correct any errors or biases in radars locations, and use of back-calculated radar location-based techniques may allow for removing a bias or error in one or more radar locations. An example arrangement configured for implementing such back-calculated radar location corrections is illustrated in and described with respect to FIG. 16. In this regard, with such approach the response of multiple radars on a common target may be used to identify any errors or offsets from one of the radars and calculating a correction factor or offset for that radar. For example, if 3 radars are tracking a golf ball and 2 radars agree but one is offset by 2 degrees in azimuth, one may apply a 2 degree offset to the less accurate radar or average out the offsets. The tracker outputs from the radars may be fed, e.g., to a common Kalman filter, the output of which drives the Kalman filters for each individual radar.

Time synchronization between the radars may also be required, such as to enable determining when the radar measurements are made and/or to time-align the measurements for a moving object. In this regard, each radar may not make the measurement at the same time, and as such time synchronization may be required to enable use of the obtained results (detection and/or position measurements), during post-processing, in creating a combined track.

Nonetheless, time synchronization related requirements may not be the same or consistent, and may vary based on different use or deployment conditions. For example, time synchronization may not be required if object (target) is stationary. On the other hand, time synchronization may be important to look for co-variance of clutter or background noise, and to remove it. Generally, time synchronization may need to meet particular threshold(s), to ensure minimal or optimal performance. The requirements for the time synchronization may be defined in terms of radar frame time. For example, in various implementations, radars may need to have time alignment, e.g., of approximately 100× better than a radar frame time.

In some implementations, time-stamps (or similar time-related data) may be used in facilitating time synchronization. For example, obtained results may be time-stamped, and the time-stamps are used to enabling time synchronizing the results during post processing.

In some instances, time synchronization may also be utilized in conjunction with other functions and/or techniques utilized in configuring and controlling operation of the multiple radars. For example, time synchronization may be used in conjunction with time-based sharing (e.g., multiplexing) related function, as described in more detail below.

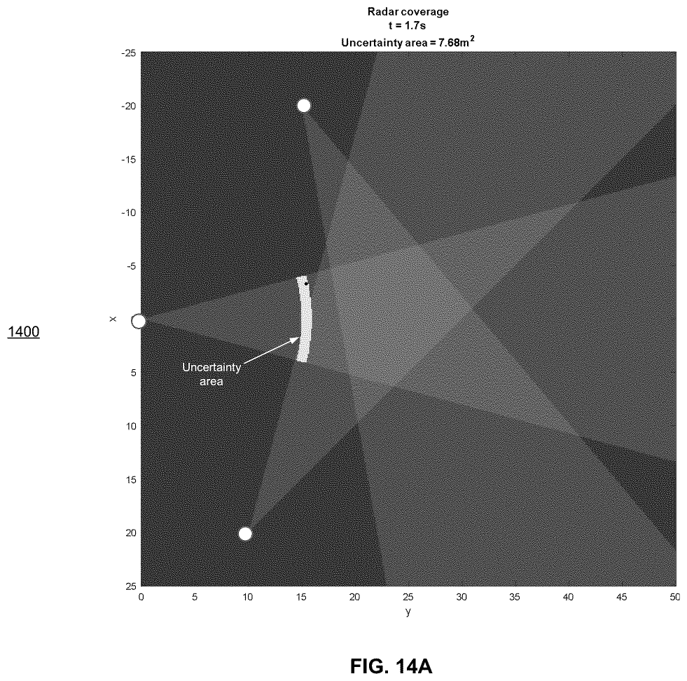

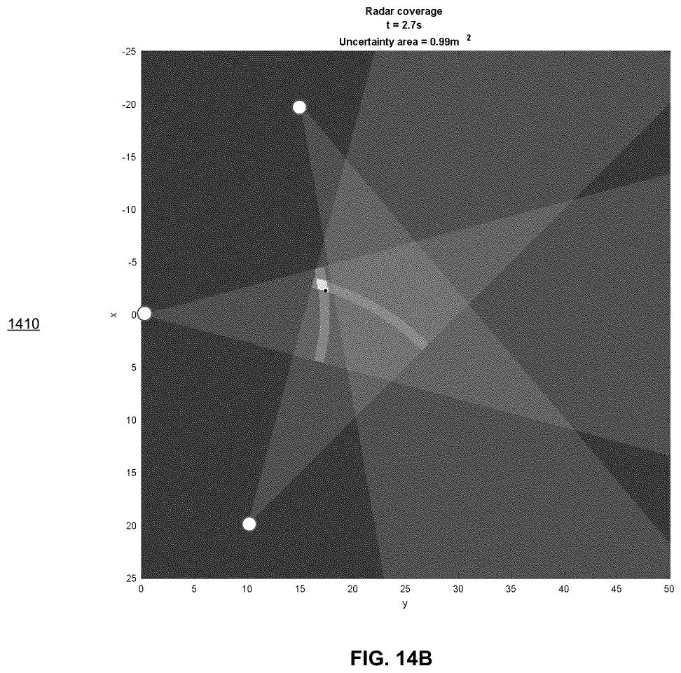

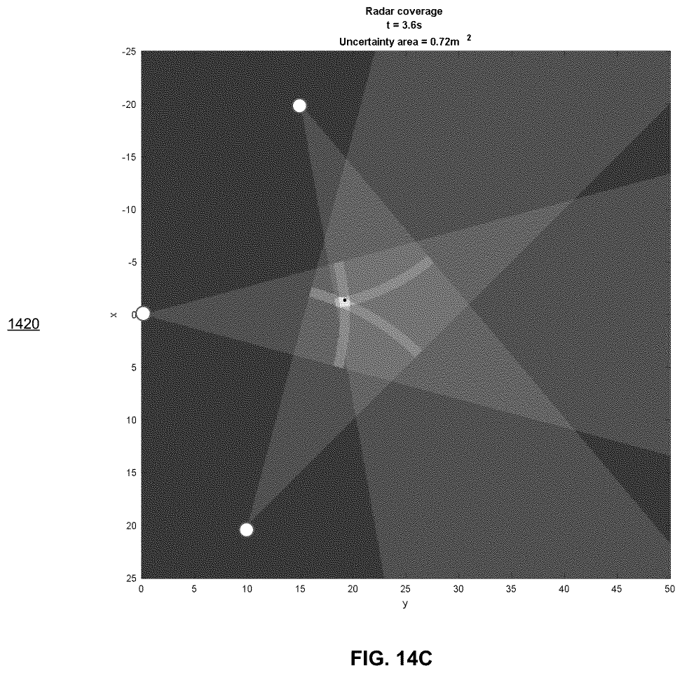

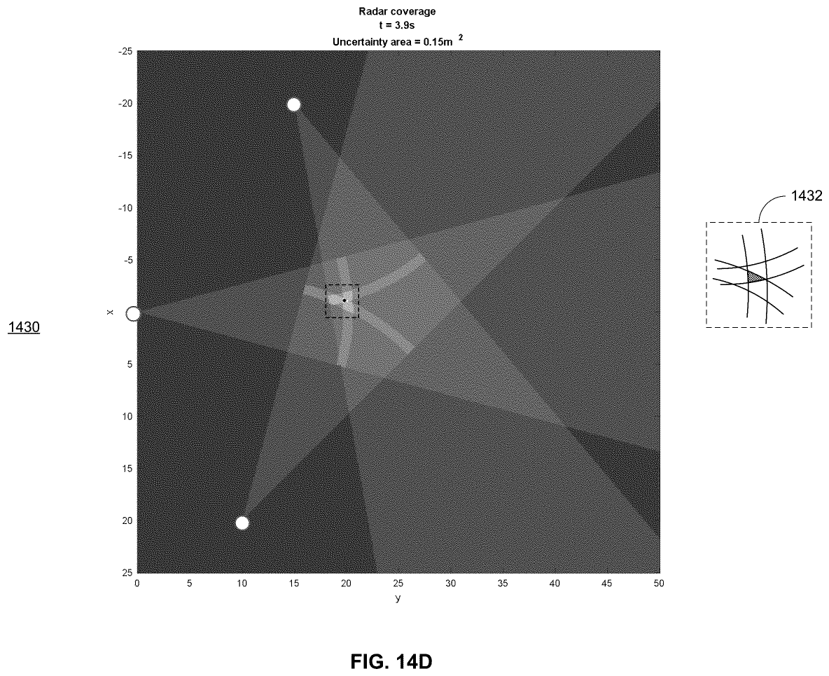

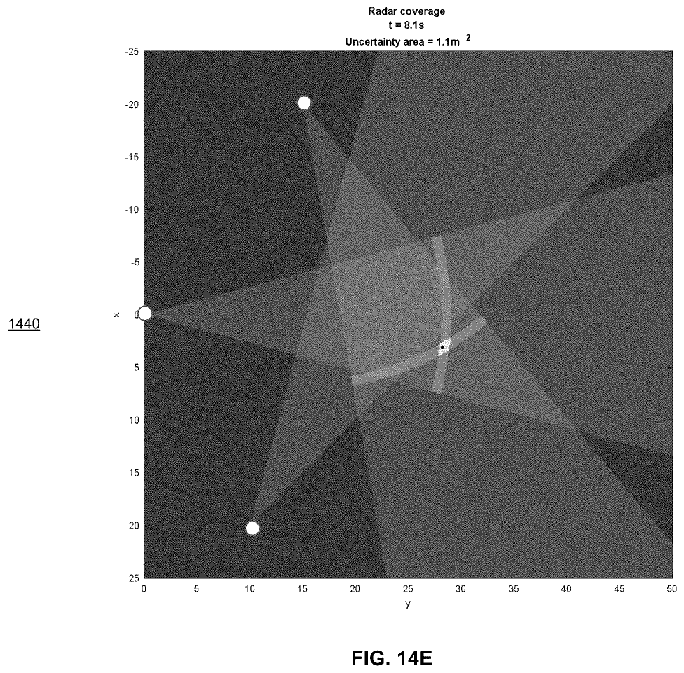

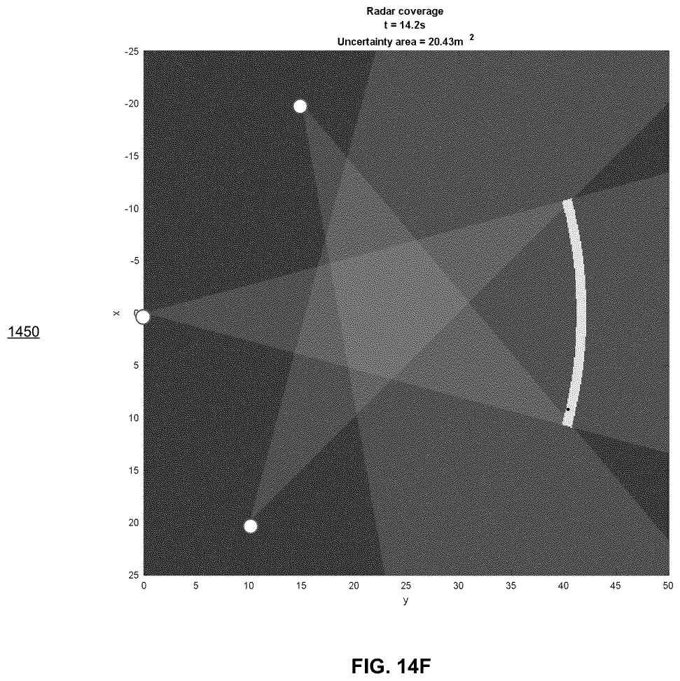

FIGS. 14A-14F illustrate an example use case demonstrating improved resolution of two-dimensional (2D) detecting and locating using multiple radars, in accordance with the present disclosure. Shown in FIGS. 14A-14F are charts 1400, 1410, 1420, 1430, 1440, and 1450.

Illustrated in each of charts 1400, 1410, 1420, 1430, 1440, and 1450 are coverage areas of multiple (3) radars. In this regard, the 3 radars may be arranged to provide overlapped coverage. For example, the 3 radars may be arranged in a similar manner as the radar arrangement corresponding to diagram 1320 in FIG. 13. The coverage areas of the 3 radars represent two-dimensions, and may be obtained based on two-dimensional (2D) simulation.

Charts 1400, 1410, 1420, 1430, 1440, and 1450 illustrate detection uncertainty (e.g., due to angular resolution errors and/or range resolution errors), and that such uncertainty may be reduced—that is, detection may be improved-when using multiple radars. The black dot represents the actual location of the target being detected. The progression of charts beginning with FIG. 14A, show a target moving further away from an initial starting point (closer to x=0, y=0). At first, the target is only in the range of one radar. As it progresses farther along the y-axis, it becomes in view of a second radar (FIG. 14B) and then a third radar (FIG. 14C). FIG. 14D has the target still in the range of three radars, but in a different position, and therefore a different level of accuracy. As the overlap of the three radars in FIG. 14D is so small, a magnified view of the area of overlap 1432 is shown. As the target continues along the y-axis, it moves out of the range of one of the radars, such that it is only in range of two radars (FIG. 14E) and then finally only in range of one radar (FIG. 14F). In this regard, the yellow area in each of these charts represents uncertainty of detections, indicating all the potential locations of the target based on, e.g., the range resolution, the beamwidth, and the orientation of the radar. As illustrated, with one radar only (charts 1400 and 1450), the uncertainty area is very large, but with coverage of 2 radars intersecting (charts 1410 and 1440) the uncertainty area is reduced. The uncertainty area is reduced even further when coverage of 3 radars intersect (charts 1420 and 1430), allowing for more accurate detection or defining position of the target.

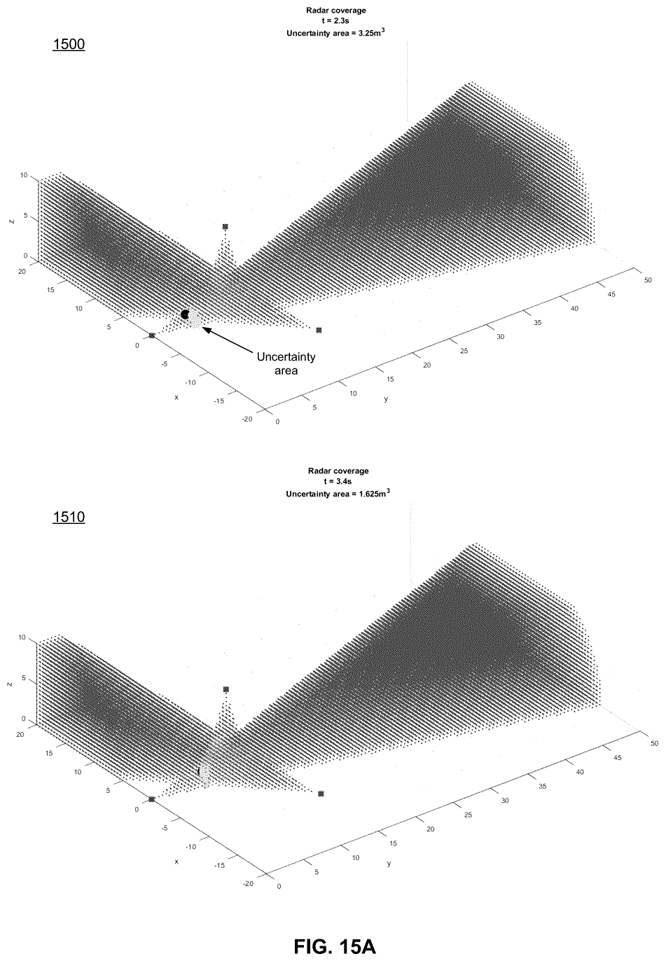

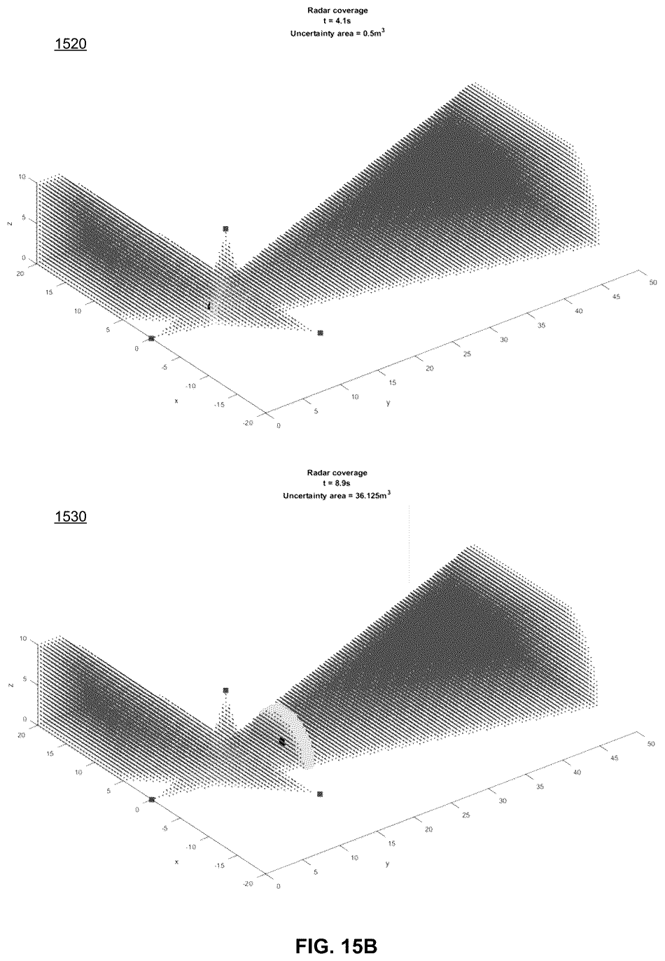

FIGS. 15A-15B illustrate example use case demonstrating improved resolution of three-dimensional (3D) detecting and locating using multiple radars, in accordance with the present disclosure. Shown in FIGS. 15A-15B are charts 1500, 1510, 1520, and 1530.

Illustrated in each of charts 1500, 1510, 1520, and 1530 are coverage areas of multiple (3) radars. In this regard, the 3 radars may be arranged to provide overlapped coverage. For example, the 3 radars may be arranged in similar manner as the radars in FIGS. 14A-14F. However, as illustrated in FIGS. 15A-15B, the coverage areas of the 3 radars represent, and may be obtained based on three-dimensional (3D) simulation.

Charts 1500, 1510, 1520, and 1530 illustrate detection uncertainty, and that such uncertainty may be reduced—that is, detection may be improved-when using multiple radars. In this regard, the yellow area in each of these charts represents uncertainty of detections. As illustrated, with one radar only (charts 1500 and 1530), the uncertainty area is very large, but with coverage of 2 or 3 radars intersect (charts 1510 and 1520) the uncertainty area is reduced, allowing for more accurate detection or defining position of the target.

While the arrangements illustrated in FIGS. 15A-15B show the 3 radars arranged in a single x-y plane, it is possible (and likely) that multiple radars may be arranged in 3-dimensions manner—that is, not in a single x-y plane. Given a three-dimensional configuration, the same concepts of detection uncertainty describe above apply.

FIG. 16 illustrates an example arrangement for back-calculated radar position determination, in accordance with the present disclosure. Shown in FIG. 16 is arrangement 1600 that is configured to provide back-calculated radar position based control, which may be used in support of detecting and accurately locating and tracking small moving objects. As illustrated, the arrangement 1600 comprises a plurality of radars 1610ₗ-1610ₙ, and an edge gateway 1620.

The plurality of radars 1610ₗ-1610ₙ, and the edge gateway 1620 may be substantially similar to the plurality of radars 610ₗ-610n and the edge gateway 620, and may be configured to operate in substantially similar manner, as described with respect to FIG. 6. However, the plurality of radars 1610ₗ-1610n and the edge gateway 1620 may be additionally configured to support use of back-calculated radar position control, for estimate and correcting bias in sensor positions, as described herein, and to do so, the plurality of radars 1610ₗ-1610n and the edge gateway 1620 may utilize circuitry and/or other resources already used therein, and/or may also incorporate additional suitable circuitry and/or other resources for facilitating back-calculated radar position control. For example, as illustrated in FIG. 16, each of the plurality of radars 1610ₗ-1610ₙ, and the edge gateway 1620 may incorporate a Kalman filter (shown as plurality of Kalman filters 1612ₗ-1612n in the plurality of radars 1610ₗ-1610ₙ, and external Kalman filter 1622 in the edge gateway 1620).

In this regard, when a network of radars are used to detect and track targets, any bias or offset in the radar positions may be estimated, such as using static targets. In order to estimate the bias in the position of one or more radars, most of the radars in the network should have accurate position. With the back-calculated radar position technique, the radars may collaboratively estimate the position of a static target. Each of the radars 1610ₗ-1610n may locally run a separate Kalman filter (corresponding one of the Kalman filters 1612ₗ-1612ₙ) to estimate the bias in its position using the range measurements it made for the static target. In this process it is assumed the estimated position of the static target is the ground truth position of the static target—that is, the actual position of an object rather than its detected position. In some instances, the radar measurements of static target(s) may be combined and used in facilitating the bias estimating at each radar. For example, the radar measurements of static target(s) may be provided by the radars 1610ₗ-1610n to the edge gateway 1620, where these measurements are processed, such as via the Kalman filter 1622, to generate position estimate(s) of static target(s). The position estimate(s) of static target(s) are then fed back to the radars 1610ₗ-1610n for used therein in generating the individual radar position bias estimates.

Time synchronization may be a critical aspect of combining data from multiple radars. In this regard, when combining data from multiple radars the data must be taken from the same moment in order to align the uncertainty areas from each radar to form the correct intersection. This is particularly important for a moving object. If the radar data is not taken exactly at the same moment, it is possible to utilize calculation techniques to combine the data, as long as the delay between data is known. With reduced precision time synchronization, the window of detection of an object will widen.

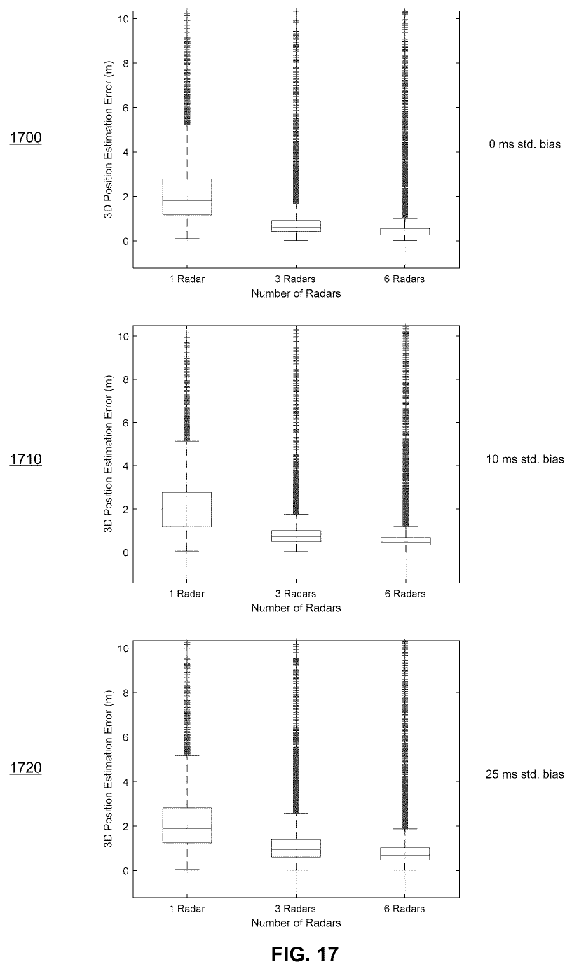

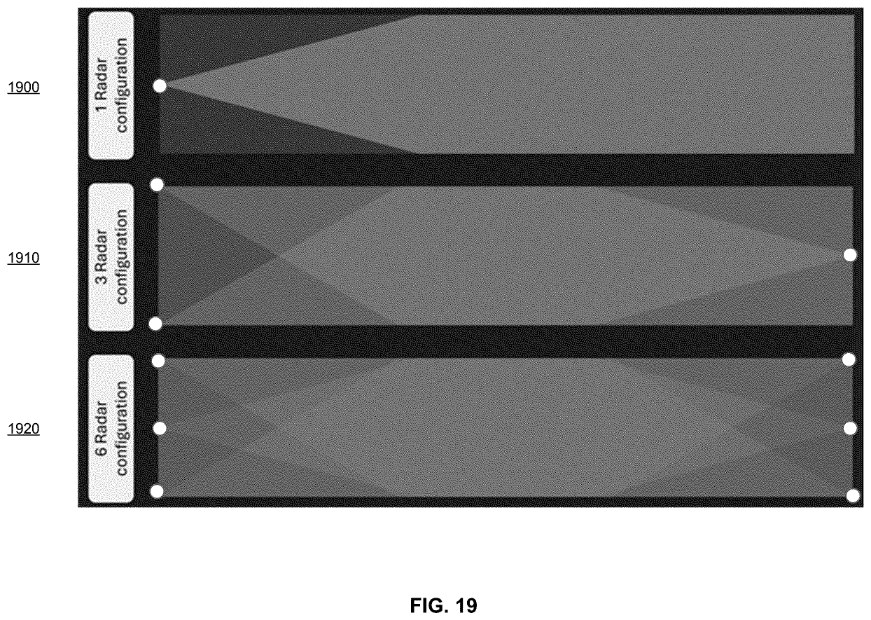

FIG. 17 illustrates effects of small errors in time synchronization when using multiple radars in detecting and tracking non-stationary targets. Shown in FIG. 17 are charts 1700, 1710, and 1720. In this regard, each of charts 1700, 1710, and 1720 illustrates three-dimensional (3D) position estimation errors (in meters) when using a single radar, 3 radars, and 6 radars. In this regard, example 1-radar, 3-radar, and 6-radar configuration and coverage thereof are illustrated and described in more detail with respect to FIG. 19.

In particular, charts 1700, 1710, and 1720 illustrates effects of time synchronization errors when using multiple radars. In this regard, when multiple radars are used to track non-stationary targets, time synchronization between the radars is important. For tracking purposes, the accuracy requirement for time synchronization depends on the speed of the target. In this regard, as long as the error due to time synchronization is less than the measurement error, tracking may be achieved with minimal, and even unnoticeable, performance degradation. This is illustrated in charts 1700, 1710, and 1720.

In this regard, as shown in chart 1700, when radars are time synchronized, use of multiple radars yields clear performance, with respect to reducing 3D position estimation errors, and the use of more radars (e.g., 6 radars vs. 3 radars) yield more improvement. Charts 1710 and 1720 show the 3D position estimation errors for similar arrangements (single radar vs. 3 radars vs. 6 radars), but with time synchronization errors—namely, 10 ms std. bias in chart 1710 and 25 ms std. bias in chart 1720. Adding radars helps improve the median and variation. The larger the number of radars, the more improvement to the median and also the variation. When comparing charts 1700, 1710, and 1720, one can see that the results for 1 radar are the same in all three charts. This is because the impact of timing errors is irrelevant to a single radar. When looking at the 3 radar and 6 radar cases, we see medians stay about the same for all three timing conditions, but the variation or standard deviation increases as the time synchronization errors increase. This is especially true for the 25 ms case represented in chart 1720. As shown, even with such time synchronization errors, there is still performance improvement when using multiple radars (and more improvement with more radars) as these errors are still less than the measurement errors. Nonetheless, it is clear that there is more performance improvement achieved with smaller time synchronization errors—that is in chart 1710 compared to chart 1720.

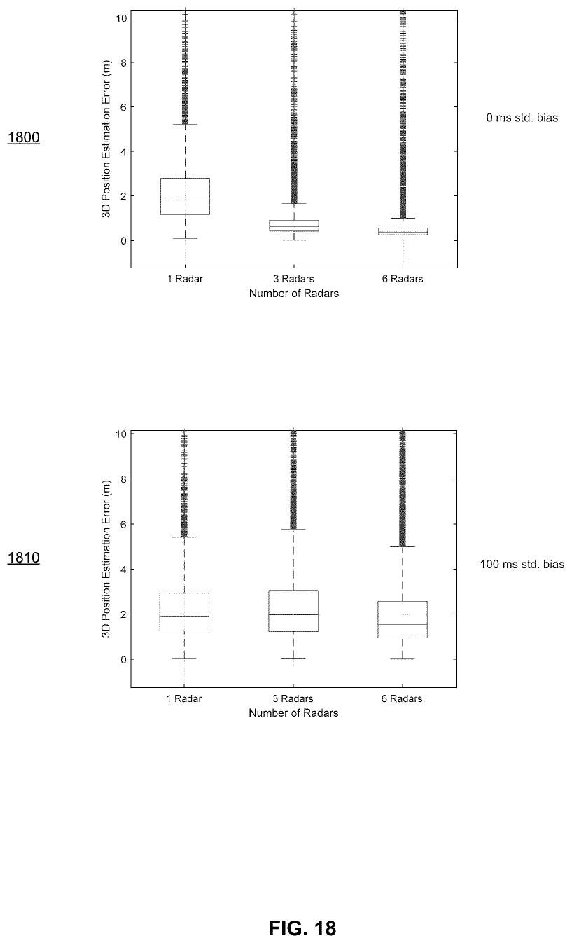

FIG. 18 illustrates effects of large errors in time synchronization when using multiple radars in detecting and tracking non-stationary targets. Shown in FIG. 18 are charts 1800 and 1810. In this regard, each of charts 1800 and 1810 also illustrates three-dimensional (3D) position estimation errors (in meters) when using a single radar, 3 radars, and 6 radars, similar to the charts 1700, 1710, and 1720 of FIG. 17.

In particular, charts 1800 and 1810 illustrate the effects of time synchronization errors when using multiple radars, and specifically when the time synchronization error is more than the measurement error. In this regard, in such instances—that is, with large time synchronization errors—there is clear performance degradation with respect to tracking outcome. This is illustrated in charts 1800 and 1810.

In this regard, as shown in chart 1800, when radars are time synchronized, use of multiple radars yields clear performance, with respect to reducing 3D position estimation errors, and the use of more radars (e.g., 6 radars vs. 3 radars) yield more improvement. Chart 1810 shows the 3D position estimation errors for similar arrangements (single radar vs. 3 radars vs. 6 radars), but with large error in time synchronization-namely, 100 ms std. bias. Such time synchronization errors are large enough-namely larger than the measurement errors—that there is substantial performance degradation, such that there is no performance improvement when using 3 radar, and very minimal improvement when using 6 radars.

FIG. 19 illustrates different example radar configurations and radar plots thereof. Shown in FIG. 19 are radar plots 1900, 1910, and 1920. In this regard, the radar plot 1900 corresponds to an example 1-radar configuration—that is, comprising a single radar. The radar plot 1910 corresponds to an example 3-radar configuration—that is, comprising 3 radars, which may be arranged, for example, along a single axis. The radar plot 1920 corresponds to an example 6-radar configuration—that is, comprising 6 radars, which may be arranged, for example, with two groups of 3 radars each, with the 3 radar in each of the two groups arranged along a single axis, as shown in FIG. 19.

The positions of the radars in FIGS. 19 of 1900, 1910, and 1920 are for generating radar plots shown in FIGS. 17 and 18. FIG. 19 shows positions of radars represented by small white circles and their corresponding radar directions. In this regard, all of the radars in these three configurations may be at particular z value (e.g., 5 m). The 3 radars in the 3-radar arrangements (corresponding to the radar plot 1910) may be arranged along a same axis. The 6 radars in the 6-radar arrangements (corresponding to the radar plot 1920) may be arranged into two groups of 3 radars each, with the 3 radars in each of the two groups arranged along a same axis, as shown. The radar arrangements may be used in tracking a same object (e.g., a golf ball). In this regard, the trajectory of the target (that is movement of the object) may be from left to right, with a constant x coordinate, varying in y and z. The actual orientation of the radars may be irrelevant for the computation of those accuracy plots because the measurements of each radar were taken and some noise may be added to each. These orientations are placed just as a reference. As illustrated by radar plots 1900, 1910, and 1920, use of more radars and/or optimal arrangement may yield smaller areas of overlap.

In example implementations, sharing related techniques may be used to further enhance detecting, locating, and/or tracking of objects using multiple radars. In this regard, as noted, the use of multiple radars in collaboratively detecting, locating, and/or tracking objects may typically necessitate sharing data from the multiple radars, with the shared data being post-process, particularly to combine the results (e.g., detection and position estimation measurements). Such data sharing may be done in different ways.

In some example implementations, the multiple radars are connected to a network node, such as an edge gateway, which may be used in handling at least portion of the post-processing. In this regard, use of such the edge gateway may be advantageous because it would typically have more and/or better processing capabilities compared to the radars. Nonetheless, the disclosure is not limited to such approach, and as such in some implementations, at least some of the post-processing of the shared data or other functions attributed herein to the edge gateway (or other network nodes) may be performed in one or more of the multiple radars.

The edge gateway may be connected to the sensing radars through wired or wireless connections. In some instances, a mesh network may be set up, comprising the radars and the edge gateway, with the mesh network facilitating connectivity and exchange of data (or other messaging) among the network elements. The edge gateway may process and combine the shared data, such as to create a composite or combined data relating to detection, location, and tracking of the targets, from the summation of the individual radar inputs. In this regard, time-stamps (or other metadata or pertinent information) associated with the shared data may be used in the processing thereof. In some instances, the tracking of the object, and/or the composite or combined data, may be in the form of point cloud data.

In some instances, multiple objects may be tracked at the same time. In this regard, the edge gateway (or whichever network element handling the post-processing of shared data) may generate separate composite or combined data for each of the objects. In this regard, in such instances one or more of the multiple radars may not observe—that is, may not be able to detect and/or locate-all of the objects (e.g., due to obstacles, orientation of the radars, etc.). The edge gateway may be configured to address such issues, such as in the context of and/or based on process the shared results.

In example implementations, multiplexing related techniques may be used to further enhance detecting, locating, and/or tracking of objects using multiple radars. In this regard, because multiple radars are utilized in the detecting, locating, and/or tracking of objects, there may be a need to ensure that the radar do not interfere with one another, such as by configuring the radars to ensure that that transmission are sufficiently separated. Such separation may be needed because at least some of the multiple radars may receive a reflection from transmitter(s) of other radar(s). In various example implementations, multiplexing techniques (e.g., TDMA, FDMA, CDMA, etc.), antenna polarization, etc., and/or any combination thereof may be used. Other techniques include modulation in general including chirp structure scanning patterns, polarization techniques, etc., and/or various combinations thereof, to ensure that transmissions by the multiple radars are sufficiently separated so that they do not interfere with each other. Chirp structure can include up chirps, down chirps, and/or non-linear chirp waveforms. In this regard, with TDMA based approach the radars may be configured to have separation in time. This may create a need to combine time segments from different radars, and various approaches may be used to do so. An example approach is described below. With FDMA based approach the radars may be assigned different frequencies, to create a separation in frequency. With CDMA based approach the radars may be configured to have separation by coding, such as by use of modulation, unique data codes, spreading codes, frequency hopping codes, etc. In some instances, passive sensing based approaches (e.g., multistatic radar based implementations) may be used, where multiple radars listen while one radar transmits. The transmitting radar would alternate between radars over time.

In one example implementation, TDMA-like approach is used, with the radars being time-synchronized, and then configured to transmit sequentially—that is, one by one. For example, the radars may use PPS (pulse per second) signals, which may be obtained from a common GPS source. To that end, the radars may incorporate ports or other means to facilitate receiving the PPS signals. The PPS signals are used to enable time synchronizing the radars. Once time synchronized, the radars may be configured to transmit in a particular sequence-looping through the multiple radars, one by one, with each radar being assigned, effectively, timeslot for its transmission. To that end, the radars may incorporate counters that are set or controlled (e.g., time synchronized) by common signal, such as by driving the counters using the PPS signals.

Time division multiplexing is one way for multiple radars to operate in the same region and same frequency. The individual radars are assigned timeslots and take turns conducting their radar operation, stopping transmission to allow another radar to use the spectrum, and then again transmitting for another predetermined timeslot. If the radars are observing the same object, they will get radar detections over different portions of the object's trajectory. By combining the returns/detections from the individual radars, especially with their associated timestamps, a common processor could ingest these data streams and combine them to form a composite, more complete track. For example, radar 1 observes an object from 0 to 10 ms, radar 2 from 10 to 20 ms, and radar 3 from 20 to 30 ms. These outputs could be combined to form a continuous track. As shown in FIG. 16, a common tracker could also feed back position estimates to the individual radars.

When using time multiplexing, the system may need to account for the fact (e.g., when tracking movement and trajectory of the target) that at some time points/intervals, only one or more of the radars may not be generating range measurements. The different measurements by the different radars may be stitched together to determine the full trajectory. For example, in some implementations, measurements corresponding to different time points may be combined, and then feeding into Kalman filter(s) (similar to the one described with respect to FIG. 16), for use in target detection and tracking.

In example implementations, advances processing techniques, such as artificial intelligence (AI) based processing, may be used to further enhance detecting, locating, and/or tracking of objects using multiple radars. In this regard, AI based processing may be used in analyzing multiple views over time of the same target, such as for classification purposes, to help in distinguishing among different targets of interest.

Accordingly, implementations based on the present disclosure may yield various benefits and/or improvements over existing solutions (if any existed) for tracking objects, particularly small moving objects. For example, with respect to target location determination, whereas conventional solutions may require use of larger antennas to reduce beamwidth, use of monopulse (standalone), and/or angle of arrival techniques, solutions based on the present disclosure allow for improve angular determination by replacing it or augmenting it with range determination of multiple radars. Also, the absolute distance associated with angular determination increases as the range increases. In this regard, range determination is not a function of range. For example, in some instances, at a distance of 300 yards the angular determination may improve from 10 yards to just over 2 yards for a few configurations. With respect to target detection, solutions based on the present disclosure allow for different viewing angles, resulting in different radar cross section variation vs. time (de-correlated) and also accommodating and accounting for different clutter environments (e.g., hills, buildings, trees, etc., which may block reception path of one or more of the radars). This helps with detection and tracking (also shadowing or log-normal variation). With respect to radar coverage areas, Distributed radar network, especially with antenna steering, results in larger regions of coverage.

An example system in accordance with the present disclosure may comprise two or more radars, physically separated, sharing data and using known radar positions to detect one or more objects. Further, various differentiation techniques may be used to ensure differentiation of the radars, to avoid interference from each other. The differentiation may comprise one or more of separating radar operation in frequency, separating radar operation in time, separating radar operation in code/modulation including techniques such as chirp sweep direction or chirp waveform, separating radar operation in polarization, and separating radar transmissions (e.g., using multistatic radars). The data may be shared with a local node (e.g., edge gateway). The shared data may comprise range and position and time. The detection may comprise one or more of triangulating a position of an object, identifying an object, target location extrapolation. At least 3 radars may be used to enable three-dimension (3D) triangulation. The physical separation may comprise one or more of having location separation that meets particular criteria (e.g., more than 1/10 the distance to a target, preferably more than ¼ the distance to a target), angle separation between the two beams meeting particular criteria (e.g., angle is >2 degrees, preferably angle is >10 degrees), having separation in location of a certain distance in one dimension (e.g. more than 1 meter), and having separation in location of a certain distance in two dimensions (e.g., three or more radars). The radars may be configured to use antenna steering. This may comprise use of electrically steerable antennas, such as phased array antennas. Such phased array antennas may comprise up to 16 elements per antenna or more such as 36 or 64. Where antenna steering is utilized, the steering time—that is, time to switch between to beam steering locations—may switch in 2 μs or less. The radars may comprise transmit and receive antennas. The transmit and receive antennas may be on a same circuit board. The radars may be Frequency-Modulated Continuous-Wave (FMCW) radars. The radars may be configured for operation in particular frequency band, such as 24 GHz operating frequency. Other examples may include operation in C, X, Ku, K, and Ka bands. The radars may be configured to meet particular power consumption criteria (e.g., power consumption <30 W). In some applications, power consumption could be up to 100 W or 150 W. The radars may be configured in time synchronized manner. This may comprise one or more being synchronized to a common reference time (e.g., central time), being synchronized to time stamp the measured data, and ensuring that obtaining measurements is coordinated in time, such as to ensure that measurements are taken at the same time.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While various spatial and directional terms, such as top, bottom, lower, mid, lateral, horizontal, vertical, front and the like may be used to describe embodiments, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the disclosed technology is not limited in its application to the details of construction and the arrangement of the components set forth in the description or illustrated in the drawings. The technology is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system comprising:
a plurality of radars; and
at least one processing node comprising one or more processing circuits;
wherein the plurality of radars are physically separated;
wherein the plurality of radars is arranged such that coverage areas of the plurality of radars overlap, at least partially;
wherein the plurality of radars is configured to utilize differentiation techniques for differentiating each of the plurality of radars;
wherein the plurality of radars is configured to share detection related data obtained or generated by each of the plurality of radars based on detection of objects within the coverage areas; and
wherein the one or more processing circuits are configured to process the shared detection related data and information relating to positions of the radars, to detect and/or track one or more objects.

2. The system of claim 1, wherein the at least one processing node comprises one of the plurality of radars.

3. The system of claim 1, wherein the at least one processing node comprises an edge gateway.

4. The system of claim 3, wherein the edge gateway is connected to a Cloud network, and wherein the edge gateway is configured to transfer or offload to the Cloud network at least a portion of the shared detection related data, or information based on the shared detection related data.

5. The system of claim 1, wherein the differentiation techniques comprise one or more of separating radar operation in frequency, separating radar operation in time, separating radar operation in code or modulation, separating radar operation in polarization, and separating radar in transmissions.

6. The system of claim 1, wherein the shared detection related data comprise data relating to one or more of range, position, and time.

7. The system of claim 1, wherein detecting and/or tracking at least one object of the one or more objects comprises one or more of triangulating a position of the at least one object, identifying the at least one object, and target location extrapolation.

8. The system of claim 1, wherein plurality of radars comprises at least three radars arranged and/or configured to enable three-dimension (3D) triangulation.

9. The system of claim 1, wherein physically separating the plurality of radars comprises arranging the plurality of radars based on particular location separation criteria.

10. The system of claim 9, wherein the particular location separation criteria comprises separating at least two radars by at least a minimum distance in at least one dimension.

11. The system of claim 9, wherein the particular location separation criteria comprises separating at least two radars by at least a separation distance that is more than ¼ a minimum distance to targets.

12. The system of claim 1, wherein physically separating the plurality of radars comprises arranging the plurality radars such angle separation between beams of at least two radars meet particular angle separation criteria.

13. The system of claim 12, wherein the particular angle separation criteria comprises having angle separation of more than 2 degrees between the beams of the at least two radars.

14. The system of claim 1, wherein one or more radars of the plurality of radars are configured to use antenna steering.

15. The system of claim 14, wherein the antenna steering comprises use of one or more electrically steerable antennas.

16. The system of claim 15, wherein the one or more electrically steerable antennas comprise at least one phased array antenna.

17. The system of claim 16, wherein the at least one phased array antenna comprise up to 16 antenna elements.

18. The system of claim 12, wherein the one or more radars are configured to switch steering time in 2 μs or less.

19. The system of claim 18, wherein the transmit and receive antennas of at least one radar of the one or more radars are on a same circuit board.

20. The system of claim 1, wherein one or more radars of the plurality of radars comprise Frequency-Modulated Continuous-Wave (FMCW) radars.

21. The system of claim 20, wherein one or more radars of the plurality of radars comprise transmit and receive antennas.

22. The system of claim 1, wherein one or more radars of the plurality of radars are configured to operate time synchronized to within 100 ms.

23. The system of claim 22, wherein operating in time synchronized manner comprises one or more of synchronization based on common reference time, synchronization based on time-stamped data, and coordinating in time obtaining of measurements.

24. The system of claim 1, wherein the plurality of radars comprises 3 or more radars arranged to have a region of overlap coverage.

25. The system of claim 1, wherein the plurality of radars comprises 6 or more radars arranged to have a region of overlap coverage.

26. The system of claim 1, wherein each radar of the plurality of radars comprises or is coupled to a Kalman filter configured for use in processing signals obtained via the radar.

27. The system of claim 26, further comprising a common Kalman filter configured to receive tracking data from the plurality of radars, and to generate one or more outputs to be fed back to each of one or more radars in the plurality of radars.

28. The system of claim 1, wherein the plurality of radars are physically separated by at least 1 meter.

29. The system of claim 1, wherein one or more radars of the plurality of radars are configured for operation in 24 GHz.

30. The system of claim 1, wherein one or more radars of the plurality of radars are configured to operate with less than 30 W.
